(19) United States
(12) Patent Application Publication
(10) Pub. No.: US 2026/0302241 A1
(43) Pub. Date: Oct. 1, 2026

(54) BINDER FOR NON-AQUEOUS ELECTROLYTE SECONDARY BATTERY ELECTRODES

(71) Applicants: TOAGOSEI CO., LTD., Tokyo (JP); Panasonic Energy Co., Ltd., Moriguchi-shi, Osaka (JP)

(72) Inventors: Kenichi YOSHIMORI, Nagoya-shi (JP); Tomoko NAKANO, Nagoya-shi (JP); Naohiko SAITO, Nagoya-shi (JP); Takashi HASEGAWA, Nagoya-shi (JP); Nobuhiro SAKITANI, Osaka (JP); Kei MISHIMA, Tokushima (JP)

(73) Assignees: TOAGOSEI CO., LTD., Tokyo (JP); Panasonic Energy Co., Ltd., Moriguchi-shi, Osaka (JP)

(21) Appl. No.: 18/998,239

(22) PCT Filed: Jul. 25, 2023
(86) PCT No.: PCT/JP2023/027156

§ 371 Date: Jan. 24, 2025

(30) Foreign Application Priority Data
Jul. 27, 2022 (JP) 2022-119850

(51) Int. Cl. H01M 4/62; C08F 220/06; H01M 10/0525

(52) U.S. Cl. CPC H01M 4/622; C08F 220/06; H01M 10/0525; C08F 2800/10; C08F 2800/20; C08F 2810/20; C08F 2810/50

(57) ABSTRACT

A binder for non-aqueous electrolyte secondary battery electrodes which minimizes the degree of electrode expansion of the non-aqueous electrolyte secondary battery includes; the binder for non-aqueous electrolyte secondary battery electrode, a crosslinked polymer that contains a carboxyl group or a salt of this crosslinked polymer. The crosslinked polymer or a salt thereof has a volume-based median diameter of 0.60 μm or more and 1.0 μm or less as measured in an acetonitrile medium, while having a degree of swelling water of 25 or more to 40 or less in a pH of 8.

### TECHNICAL FIELD

The present invention relates to a binder that can be used in a non-aqueous electrolyte secondary battery such as a lithium-ion secondary battery.

### CROSS-REFERENCE TO RELATED APPLICATIONS

This application claims priority to Japanese Patent Application No. 2022-119850 filed on Jul. 27, 2022, the contents of which are hereby incorporated by reference into the present application.

### BACKGROUND ART

For example, an electrode for a non-aqueous electrolyte secondary battery such as a lithium-ion secondary battery is produced by applying a composition for forming an electrode mixture layer containing an active material, a binder and the like (hereinafter also referred to as an electrode mixture layer composition) onto a current collector and drying it.

In order to increase the electric capacity of lithium-ion secondary batteries, silicon-based active materials are increasingly being used as negative electrode active materials. On the other hand, silicon-based active materials undergo large volume change during charging and discharging, a negative electrode mixture layer easily peels off or falls off accordingly, and as a result, the battery capacity may decrease and cycle properties may deteriorate. Therefore, it has been reported that an acrylic acid-based polymer having excellent binding properties is effective in order to reduce such problems in the negative electrode mixture layer (Patent Literature 1 and Patent Literature 2).

Patent Literature 1 discloses a binder containing a crosslinked acrylic acid polymer obtained by crosslinking polyacrylic acid with a specific crosslinking agent. It discloses that, even when a silicon-containing active material is used, an electrode structure is not destroyed and favorable cycle properties are exhibited. Patent Literature 2 discloses an aqueous electrode binder for secondary batteries containing a water-soluble polymer including a structural unit derived from ethylenically unsaturated carboxylate monomers and a structural unit derived from highly hydrophilic ethylenically unsaturated monomers not containing carboxylic acids.

### CITATION LIST

Patent Literature 1: WO 2014/065407
Patent Literature 2: WO 2016/067633

The binder disclosed in Patent Literature 1 and Patent Literature 2 can prevent an active material from peeling off from a current collector according to improvement in binding performance. However, it has been found that the expansion of electrodes after repeated charging and discharging (hereinafter also referred to as a degree of electrode expansion) cannot always be minimized. Such an increase in the degree of electrode expansion causes an increase in the number of conduction path disconnections due to a large change in the electrode structure and eventually causes deterioration of cycle properties. In addition, it has been found that the coating performance, which allows an electrode slurry containing a binder to be stably and uniformly supplied to a current collector and the like, has a significant influence on the productivity and battery performance of secondary batteries.

The disclosure of this specification has been made in view of the above circumstances, and an object of the disclosure is to provide a binder for non-aqueous electrolyte secondary battery electrodes, which minimizes the degree of electrode expansion of a non-aqueous electrolyte secondary battery to achieve excellent cycle properties, and allows an electrode mixture layer composition to exhibit excellent coating properties.

### SUMMARY

The inventors conducted extensive studies in order to address the above problems, and as a result, focused on, regarding a binder used for binding an active material and the like, the particle size and the degree of swelling in an aqueous medium (hereinafter referred to as “degree of swelling in water”) under predetermined conditions. As a result, they found that, in a binder containing a crosslinked polymer or a salt thereof, when the particle size and the degree of swelling in water are controlled under predetermined conditions, it is possible to contribute to minimizing the degree of electrode expansion after charging according to charging and discharging cycles. In addition, they found that the binder can simultaneously contribute to improving cycle properties and coating properties. The present disclosure provides the following aspects based on these findings.
[1]A binder for non-aqueous electrolyte secondary battery electrodes, including a crosslinked polymer having a carboxyl group or a salt thereof,
   wherein the crosslinked polymer or a salt thereof has a particle size measured in an acetonitrile medium that is 0.60 μm or more and 1.0 μm or less in terms of volume-based median diameter and has a degree of swelling in water at pH 8 that is 25 or more and 40 or less.
[2] The binder for non-aqueous electrolyte secondary battery electrodes according to [1],
   wherein the crosslinked polymer or a salt thereof contains 60 mass % or more and 99.9 mass % or less of a first structural unit derived from an ethylenically unsaturated carboxylic acid monomer or a salt thereof and 0.1 mass % or more and 40 mass % or less of a second structural unit derived from a nitrogen-containing ethylenically unsaturated monomer.
[3] The binder for non-aqueous electrolyte secondary battery electrodes according to [2],
   wherein the second structural unit includes a structural unit derived from acryloylmorpholine.
[4] The binder for non-aqueous electrolyte secondary battery electrodes according to any one of [1] to [3],
   wherein the crosslinked polymer or a salt thereof is a crosslinked polymer obtained by polymerizing a monomer composition containing a non-crosslinkable monomer and a crosslinkable monomer.
[5] The binder for non-aqueous electrolyte secondary battery electrodes according to [4],
   wherein the amount of the crosslinkable monomer used based on a total amount of the non-crosslinkable monomer is 0.1 mol % or more and 1.0 mol % or less.
[6] The binder for non-aqueous electrolyte secondary battery electrodes according to [4] or [5],
   wherein the crosslinkable monomer includes a crosslinkable monomer having two or more (meth)acryloyl groups and a hydroxyl group in one molecule.
[7] The binder for non-aqueous electrolyte secondary battery electrodes according to any one of [1] to [6],
   wherein the crosslinked polymer or a salt thereof has a particle size of 0.75 μm or more and 0.95 μm or less and a degree of swelling in water of 27.9 or more and 36.8 or less, and is a lithium salt having a degree of neutralization of 80 mol % or more.
[8] The binder for non-aqueous electrolyte secondary battery electrodes according to any one of [1] to [7],
   wherein the crosslinked polymer or a salt thereof contains a 70 mass % or more and 99 mass % or less of a first structural unit derived from an ethylenically unsaturated carboxylic acid monomer or a salt thereof and 1 mass % or more and 30 mass % or less of a second structural unit derived from a nitrogen-containing ethylenically unsaturated monomer, and wherein the second structural unit includes a structural unit derived from acryloylmorpholine.
[9] A non-aqueous electrolyte secondary battery, including a negative electrode containing the binder for non-aqueous electrolyte secondary battery electrodes according to any one of [1] to [8], a positive electrode, and a non-aqueous electrolyte.

### Advantageous Effects

The binder for secondary battery electrodes disclosed in this specification (hereinafter simply referred to as a binder) contains a crosslinked polymer having a carboxyl group or a salt thereof. The binder has a predetermined particle size and a predetermined degree of swelling in water under specific conditions, and thus can minimize the degree of electrode expansion of non-aqueous electrolyte secondary batteries. Therefore, it is possible to improve cycle properties of the secondary battery. In addition, the binder allows the electrode mixture layer composition to exhibit excellent coating properties. Therefore, the binder can contribute to stable battery performance and contribute to improving the productivity of secondary battery electrodes and secondary batteries.

### BRIEF DESCRIPTION OF DRAWINGS

FIG. 1 is a diagram showing a device used for measuring the degree of swelling in water of a crosslinked polymer or a salt thereof.

### DESCRIPTION OF EMBODIMENTS

The binder disclosed in this specification contains a crosslinked polymer having a carboxyl group or a salt thereof. The binder is generally mixed with an active material and water to form an electrode mixture layer composition in a slurry state that can be applied to a current collector. The crosslinked polymer or a salt thereof has a predetermined particle size in an acetonitrile medium and a degree of swelling in water at pH 8 that are controlled. Therefore, the degree of electrode expansion after charging and discharging can be minimized, which can contribute to excellent cycle properties as a result. In addition, it can also contribute to excellent coating properties.

In the related art, the expansion of an electrode of a secondary battery that has been repeatedly charged and discharged is minimized by applying a load to the secondary battery using a housing (case) that accommodates the secondary battery. However, the binder disclosed in this specification has an expansion minimizing ability with which it can minimize the degree of electrode expansion in the binder itself. This may allow the structure of the case of the secondary battery to be simplified and its strength to be reduced.

Regarding the crosslinked polymer or a salt thereof, a particle size and degree of swelling in water can be good indexes of this electrode expansion degree minimizing ability and coating performance, as will be described later. The inventors have found that, when the particle size and the degree of swelling in water are too small, the degree of electrode expansion decreases, and when the particle size and the degree of swelling in water are too large, the degree of electrode swelling decreases. It is thought that, when a crosslinked polymer or a salt thereof that has these indexes is used, it is possible to exhibit favorable adhesion and conformability with respect to an active material such as a silicon-based active material that has strong expansion and contraction properties in an electrode mixture layer. Accordingly, it is thought that the collapse of the electrode structure due to expansion and contraction of the active material during charging and discharging can be prevented, and thereby it can contribute to minimizing the degree of electrode expansion. In addition, the inventors found that, when having these indexes, excellent improvement in coating properties is also achieved. This is thought to be because these indexes indicate excellent dispersibility of active materials and other components in an electrode mixture layer composition.

Here, although this is merely speculative and does not restrict the disclosure of this specification, when the particle size and the degree of swelling in water are equal to or above a certain level, the probability of binding within the active material increases, and binding properties are improved. On the other hand, when the particle size is too large, the number of crosslinked polymer salt molecules per unit mass decreases, and the number of binding points decreases accordingly. In addition, when the degree of swelling in water is too large, the mechanical properties of the crosslinked polymer salt deteriorate, and the binding strength per unit number decreases accordingly. Therefore, it is thought that there is an optimum point between the particle size and the degree of swelling in water.

Representative and non-limiting specific examples of the disclosure of this specification will be appropriately described below in detail with reference to the drawings. The detailed description is intended simply to provide details for implementing preferable examples of the present invention for those skilled in the art, and is not intended to limit the scope of the disclosure of this specification. In addition, additional features and inventions disclosed below can be used separately from or together with other features and inventions in order to provide a further improved binder for non-aqueous electrolyte secondary battery electrodes.

In addition, the combinations of features and steps disclosed in the following detailed description are not essential for implementing the present invention in the broadest sense, but are specifically described only to illustrate representative specific examples of the disclosure of this specification. In addition, various features of the representative specific examples described above and below, and various features of those described in independent and dependent claims do not have to be combined exactly as in specific examples described herein or the order listed to provide additional and useful embodiments of the disclosure of this specification.

All features described in this specification and/or claims are intended to be disclosed individually or independently of one another as limitations to the disclosure at the time of filing and claimed specific matters, separately from configurations of features described in examples and/or claims. In addition, the descriptions of all numerical value ranges and groups or collections are intended to disclose their intermediate configurations as limitations to the disclosure at the time of filing and claimed specific matters.

Hereinafter, a binder disclosed in this specification, and an electrode mixture layer composition and secondary battery electrode obtained using the binder will be described in detail.

Here, in this specification, “(meth)acrylic” refers to acrylic and/or methacrylic, and “(meth)acrylate” refers to an acrylate and/or a methacrylate. In addition, “(meth)acryloyl group” refers to an acryloyl group and/or a methacryloyl group.

### <Binder>

The binder disclosed in this specification can contain a crosslinked polymer having a carboxyl group or a salt thereof. Hereinafter, the particle size and degree of swelling in water of the crosslinked polymer or a salt thereof will be described, and the structural units of the crosslinked polymer and the like will be described below.

### <Particle Size of Crosslinked Polymer or a Salt Thereof in Acetonitrile Medium>

The measured particle size of the crosslinked polymer or a salt thereof in an acetonitrile medium is, for example, 0.60 μm or more and 1.0 μm or less, in terms of volume-based median diameter. When the particle size is within this range, the degree of electrode expansion can be effectively minimized and deterioration of cycle properties can be curbed accordingly. In addition, when the particle size is less than 0.60 μm, the degree of electrode expansion tends to increase, and when the particle size is more than 1.0 μm, the degree of electrode expansion tends to increase.

The lower limit of the particle size is, for example, 0.62 μm, for example, 0.65 μm, for example, 0.66 μm, for example, 0.67 μm, for example, 0.68 μm, for example, 0.69 μm, for example, 0.70 μm, for example, 0.71 μm, for example, 0.72 μm, for example, 0.73 μm, for example, 0.74 μm, for example, 0.75 μm, for example, 0.76 μm, for example, 0.77 μm, or for example, 0.78 μm. The upper limit of the particle size is, for example, 0.99 μm, for example, 0.97 μm, for example, 0.95 μm, for example, 0.93 μm, for example, 0.91 μm, or for example, 0.89 μm.

The particle size range can be arbitrarily selected from the above lower limit and upper limit, and is, for example, 0.65 μm or more and 1.0 μm or less, for example, 0.75 μm or more and 1.0 μm or less, for example, 0.75 μm or more and 0.99 μm or less, for example, 0.75 μm or more and 0.95 μm or less, or for example, 0.76 μm or more and 0.95 μm or less.

In this specification, the particle size in an acetonitrile medium refers to the particle size of the crosslinked polymer or a salt thereof when not substantially swollen with water. 5.0 g of acetonitrile with a purity of 99.5 mass % or more is added to 1.0 g of a crosslinked polymer or a salt thereof powder, and ultrasonic waves are emitted using an ultrasonic homogenizer (for example, commercially available from Yamato Scientific Co., Ltd., LUH150 or an equivalent device) at an output of 25 W for 30 seconds to obtain a dispersion. The particle size distribution of the dispersion is measured using a laser diffraction/scattering particle size distribution analyzer (Microtrac MT-3300EXII, commercially available from MicrotracBELCorporation) using the acetonitrile as a dispersion medium. 0.05 mL of the dispersion is added to an excess amount of the dispersion medium that is circulating, and an appropriate scattered light intensity is obtained. Then, once the particle size distribution shape is confirmed to be stable a few minutes later, the particle size distribution is measured, and a volume-based median diameter (D50) is obtained as a representative value of the particle size.

In this specification, the degree of electrode expansion is the ratio (%) of increase in the thickness of the negative electrode that is charged again after charging and discharging under predetermined conditions to the thickness of the negative electrode before charging and discharging. The negative electrode expands during charging and contracts during discharging, and when charging and discharging are repeated, the electrode expands from an initial state, and reaches a thickness that is maintained in the negative electrode during charging.

More specifically, the degree of electrode expansion can be measured as follows. That is, the battery is charged and discharged a predetermined number of times, and after the final charging, the battery is disassembled, the negative electrode (negative electrode mixture layer) is removed, washing is performed using a solvent that does not influence the original components of the negative electrode, and the thickness (T₂) is then measured. As a control, the thickness (T₁) of the mixture layer after coating and rolling is measured for each electrode having the same configuration. The degree of electrode expansion is calculated using these thicknesses (T₁, T₂) according to the following Computation Formula (1).

$$Degree of electrode expansion = ( {T}_{2} - {T}_{1} ) / {T}_{1} \times 100 ( \% ) \qquad ( 1 )$$

Here, the number of times charging and discharging are performed and the charging and discharging conditions are appropriately set depending on the battery. For example, the number of times charging and discharging are performed can be set in a range of several to 5,000. In addition, the thickness of the negative electrode can be measured with a contact type micrometer. A specific example of the method for measuring the degree of electrode expansion is disclosed in examples.

Those skilled in the art can, based on common technical knowledge at the time of filing this application in addition to the compositions and the like in examples in this specification, control the composition and structure of the crosslinked polymer or a salt thereof and adjust the particle size in the acetonitrile medium. For example, the particle size can be increased by introducing a second structural unit to be described below. In addition, the particle size can be increased by increasing the initial monomer concentration during polymerization.

### <Degree of Swelling in Water at pH 8 of Crosslinked Polymer or Salt Thereof>

The degree of swelling in water at pH 8 of the crosslinked polymer or a salt thereof is, for example, 25.0 or more and 40.0 or less. Within this range, coating properties with respect to the current collector and the binder adhesion to the current collector can be simultaneously satisfied. Regarding the degree of swelling in water, when the degree of swelling in water is less than 25.0, the adhesion may decrease and cycle properties may deteriorate, and when the degree of swelling in water is more than 40.0, coating properties may deteriorate.

In this specification, the degree of swelling in water is calculated based on the following Computation Formula (2) from the dry mass “(WA)g” of the crosslinked polymer or a salt thereof, and the water content “(WB)g” absorbed when the crosslinked polymer or a salt thereof is saturated and swollen with water at pH 8.

$$( Degree of swelling in water ) = \{ ( WA ) + ( WB ) \} / ( WA ) \qquad ( 2 )$$

In consideration of the degree of electrode expansion, coating properties and the like, the lower limit of the degree of swelling in water at pH 8 is, for example, 25.5, for example, 26.0, for example, 27.0, for example, 27.5, for example, 27.9, for example, 28.0, for example, 28.5, for example, 28.9, for example, 29.0, or for example, 29.2. In consideration of the degree of electrode expansion, coating properties, adhesion and the like, the upper limit of the degree of swelling in water is, for example, 39.0, for example, 38.7, for example, 38.5, for example, 38.0, for example, 37.5, for example, 37.0, for example, 36.8, for example, 36.5, for example, 36.0, for example, 35.5, for example, 35.0, or for example, 34.6. The range of the degree of swelling in water can be arbitrarily selected from the above lower limit and upper limit, and is, for example, 25.0 or more and 39.0 or less, for example, 27.5 or more and 37.4 or less, for example, 28.5 or more and 37.4 or less, or for example, 29.0 or more and 35.0 or less. In addition, the range is, for example, 27.9 or more and 36.8 or less, for example, 28.5 or more and 36.8 or less, or for example, 29.2 or more and 36.8 or less.

The degree of swelling in water at pH 8 can be determined by measuring the degree of swelling in water of the crosslinked polymer or a salt thereof in water at pH 8. As the water at pH 8, for example, ion-exchanged water can be used, and as necessary, the pH value may be adjusted using a suitable acid or alkali, a buffer solution or the like. In addition, the measurement is performed at 25±5° C. A specific example of a method for measuring the degree of swelling in water is disclosed in examples.

Those skilled in the art can, based on common technical knowledge at the time of filing this application in addition to the compositions and the like in examples in this specification, control the composition and structure of the crosslinked polymer or a salt thereof and adjust the degree of swelling in water. For example, the degree of swelling in water can be adjusted according to the amount of the second structural unit to be described below introduced, and generally, the degree of swelling in water can be increased by introducing such structural units. In addition, generally, the degree of swelling in water can be increased by decreasing the degree of crosslinking of the crosslinked polymer. In addition, the degree of swelling in water can be increased by increasing the initial monomer concentration during polymerization. In addition, when a crosslinked polymer is manufactured by precipitation polymerization or dispersion polymerization, the degree of swelling in water can be adjusted by controlling the timing at which monomers from which a second structural unit to be described below is derived are added or a method of adding the monomers.

### <Structural Units of Crosslinked Polymer or a Salt Thereof>

The crosslinked polymer or a salt thereof may contain a first structural unit derived from an ethylenically unsaturated carboxylic acid monomer and a second structural unit derived from a nitrogen-containing ethylenically unsaturated monomer.

### <First Structural Unit>

The crosslinked polymer or a salt thereof may have a first structural unit derived from an ethylenically unsaturated carboxylic acid monomer (hereinafter also referred to as a “component (a)”). When the crosslinked polymer or a salt thereof has a carboxyl group due to the inclusion of the structural unit, since the adhesion to a current collector is improved, and the lithium ion desolvation effect and ion conductivity are excellent, an electrode having low resistance and excellent high-rate properties is obtained. In addition, since the structural unit imparts a property of swelling in water, it is possible to improve the dispersion stability of active materials and the like in the electrode mixture layer composition.

The component (a) can be introduced into a crosslinked polymer or a salt thereof, for example, by polymerizing ethylenically unsaturated carboxylic acid monomers or salts thereof. Alternatively, it can be obtained by (co)polymerizing (meth)acrylate monomers and then hydrolyzing. In addition, (meth)acrylamide, (meth)acrylonitrile and the like may be polymerized and then treated with a strong alkali, or a method of reacting a polymer having a hydroxyl group with an acid anhydride may be used.

Examples of ethylenically unsaturated carboxylic acid monomers include (meth)acrylic acid, itaconic acid, crotonic acid, maleic acid, fumaric acid, (meth)acrylamidohexanoic acid; (meth)acrylamide alkylcarboxylic acids such as (meth)acrylamidododecanoic acid, ethylenically unsaturated monomers having carboxyl groups, such as succinic acid monohydroxyethyl (meth)acrylate, ω-carboxy-caprolactone mono(meth)acrylate and β-carboxyethyl (meth)acrylate, and (partially) alkali neutralized products of these, and one of these alone or a combination of two or more may be used. Among the above examples, a compound having an acryloyl group as a polymerizable functional group is preferable and acrylic acid is particularly preferable because it can provide polymers with a long primary chain length due to its high polymerization speed and favorable binder adhesion. When acrylic acid is used as an ethylenically unsaturated carboxylic acid monomer, a polymer having a large carboxyl group content can be obtained.

The content of the component (a) in the crosslinked polymer or a salt thereof is not particularly limited, and it may be, for example, 60 mass % or more and 99.9 mass % or less with respect to all structural units derived from non-crosslinkable monomers of the crosslinked polymer. When the component (a) is contained in such a range, it is possible to easily secure excellent adhesion to the current collector. The lower limit is, for example, 65 mass %, for example, 70 mass %, for example, 75 mass %, for example, 80 mass %, for example, 85 mass %, for example, 90 mass %, for example, 95 mass %, for example, 98 mass %, for example, 98.5 mass %, or for example, 99 mass %. In addition, the upper limit is, for example, 99.8 mass %, for example, 99.5 mass %, for example, 99 mass %, for example, 98 mass %, or for example, 98.5 mass %. The range can be a range in which these lower limits and upper limits are appropriately combined, and may be, for example, 70 mass % or more and 99.9 mass % or less, for example, 70 mass % or more and 99 mass % or less, for example, 80 mass % or more and 99 mass % or less, or for example, 85 mass % or more and 99 mass % or less.

Here, the content of the component (a) in the crosslinked polymer or a salt thereof can be determined from the amount of the monomer prepared when the crosslinked polymer is manufactured.

### <Second Structural Unit>

The crosslinked polymer or a salt thereof may have, in addition to the component (a), a second structural unit derived from a nitrogen-containing ethylenically unsaturated monomer (hereinafter also referred to as a “component (b)”). When the crosslinked polymer or a salt thereof contains the component (b), it can contribute to improving coating properties of the electrode mixture layer composition obtained using the crosslinked polymer or a binder containing a salt thereof and reducing the degree of electrode expansion.

For example, the component (b) can be introduced into the crosslinked polymer or a salt thereof by polymerizing one or two or more monomers selected from the group consisting of monomers represented by the following Formula (1) with monomers from which the first structural unit is derived.

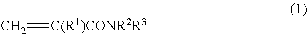

[wherein, R¹ represents a hydrogen atom or a methyl group, and R² and R³ each represent a hydrogen atom, an alkyl group having 1 to 4 carbon atoms, or a hydroxy alkyl group having 1 to 4 carbon atoms, or are linked together to form an oxygen-containing cyclic saturated hydrocarbon group containing a nitrogen atom in Formula (1) or the cyclic saturated hydrocarbon group containing a nitrogen atom].

The monomers represented by Formula (1) are (meth)acrylamide derivatives. In Formula (1), alkyl groups having 1 to 4 carbon atoms for R² and R³ may be linear or branched. R² and R³ each independently represent, for example, a methyl group, an ethyl group, an n-propyl group, an isopropyl group, an n-butyl group, a sec-butyl group, a tert-butyl group or the like. Examples of hydroxy alkyl groups having 1 to 4 carbon atoms for R² and R³ include the above hydroxy alkyl groups in which an alkyl group having 1 to 4 carbon atoms has a hydroxyl group at the terminal, such as a hydroxymethyl group, a hydroxyethyl group, a hydroxypropyl group, and a hydroxybutyl group.

Examples of oxygen-containing cyclic saturated hydrocarbon groups containing a nitrogen atom in Formula (1), represented by R² and R³ when linked together, include a 5- to 7-membered oxygen-containing cyclic saturated hydrocarbon group containing a nitrogen atom. Examples of such cyclic saturated hydrocarbon groups include a morpholino group. In addition, examples of cyclic saturated hydrocarbon groups containing a nitrogen atom in Formula (1), represented by R² and R³ when linked together, include a 5- to 7-membered cyclic saturated hydrocarbon group containing a nitrogen atom, such as a piperidino group.

Examples of monomers represented by Formula (1) include N,N-dialkyl(meth)acrylamides such as N,N-dimethylacrylamide, N,N-diethyl(meth)acrylamide, and N,N-di-n-propyl(meth)acrylamide when both R² and R³ are an alkyl group, N-alkyl(meth)acrylamides such as N-methyl(meth)acrylamide and N-ethyl(meth)acrylamide when one of R² and R³ is a hydrogen atom and the other is an alkyl group, N-hydroxyalkyl(meth)acrylamides such as N-hydroxyethyl(meth)acrylamide, N-hydroxypropyl(meth)acrylamide, N-hydroxybutyl(meth)acrylamide, N-methyl-N-hydroxyethyl(meth)acrylamide and N-ethyl-N-hydroxyethyl(meth)acrylamide when one of R² and R³ is a hydrogen atom or an alkyl group and the other is a hydroxy alkyl group, N,N-dihydroxyalkyl(meth)acrylamides such as N,N-dihydroxymethyl(meth)acrylamide and N,N-dihydroxyethyl(meth)acrylamide when R² and R³ are a hydroxy alkyl group, and N-cyclic saturated hydrocarbon groups such as (meth)acryloyl morpholine and (meth)acryloyl piperidine when R² and R³ are linked together to form an oxygen-containing cyclic saturated hydrocarbon group containing a nitrogen atom in Formula (1) or the cyclic saturated hydrocarbon group containing a nitrogen atom. The monomers represented by Formula (1) may be used alone or two or more thereof may be used in combination.

Examples of second structural units include N,N-dialkyl(meth)acrylamides such as (meth)acryloyl morpholine and N,N-dimethylacrylamide, and N-hydroxyalkyl(meth)acrylamides such as hydroxyethyl(meth)acrylamide because they are excellent in minimizing the degree of electrode expansion and improving coating properties of the electrode mixture layer composition. In addition, a compound having an acryloyl group as a polymerizable functional group is preferable because it can provide a polymer with a long primary chain length due to its high polymerization speed and favorable binder adhesion. Accordingly, acryloyl morpholine, N,N-dimethylacrylamide, and N-hydroxyethylacrylamide may be suitably used.

The content of the component (b) in the crosslinked polymer or a salt thereof is not particularly limited, and may be, for example, 0.1 mass % or more and 40 mass % or less with respect to all structural units derived from non-crosslinkable monomers of the crosslinked polymer. When the component (b) is contained in such a range, it is possible to minimize the degree of electrode expansion and allow the electrode mixture layer composition to exhibit favorable coating properties. The upper limit is, for example, 35 mass %, for example, 30 mass %, for example, 25 mass %, for example, 20 mass %, for example, 15 mass %, for example, 10 mass %, for example, 5 mass %, for example, 2 mass %, for example, 1.5 mass %, or for example, 1 mass %. In addition, the lower limit is, for example, 0.2 mass %, for example, 0.5 mass %, for example, 1 mass %, or for example, 1.5 mass %. The range can be a range in which these lower limits and upper limits are appropriately combined, and may be, for example, 0.1 mass % or more and 30 mass % or less, for example, 1 mass % or more and 30 mass % or less, for example, 1 mass % or more and 20 mass % or less, for example, or 1 mass % or more and 15 mass % or less.

Here, the content of the component (b) in the crosslinked polymer or a salt thereof can be determined from the amount of the monomer prepared when the crosslinked polymer is manufactured.

### <Other Structural Units>

This crosslinked polymer may contain, in addition to the component (a) and the component (b), a structural unit derived from another non-crosslinkable ethylenically unsaturated monomer copolymerizable therewith (hereinafter also referred to as a “component (c)”). Examples of components (c) include structural units derived from an ethylenically unsaturated monomer compound having an anionic group other than a carboxyl group such as a sulfonic acid group and a phosphate group and structural units derived from a non-ionic ethylenically unsaturated monomer other than the component (b). These structural units can be introduced by copolymerizing an ethylenically unsaturated monomer compound having an anionic group other than a carboxyl group such as a sulfonic acid group and a phosphate group or monomers including a non-ionic ethylenically unsaturated monomer other than the component (b). Among these, as the component (c), a structural unit derived from a non-ionic ethylenically unsaturated monomer is preferable because it can provide an electrode having favorable bending resistance, and (meth)acrylamide and its derivatives, a nitrile group-containing ethylenically unsaturated monomer and the like are preferable because they provide excellent binder adhesion. In addition, when a structural unit derived from a hydrophobic ethylenically unsaturated monomer having a solubility in water of 1 g/100 ml or less is introduced as the component (c), a strong interaction with the electrode material can be exhibited and favorable adhesion to the active material can be exhibited. This is preferable because it is possible to obtain an electrode mixture layer that is strong and has favorable integrity. Particularly, a structural unit derived from an alicyclic structure-containing ethylenically unsaturated monomer is preferable.

The proportion of the component (c) with respect to all structural units derived from non-crosslinkable monomers of the crosslinked polymer may be 0 mass % or more and 49.5 mass % or less. The proportion of the component (c) may be 1 mass % or more and 40 mass % or less, 2 mass % or more and 40 mass % or less, 2 mass % or more and 30 mass % or less, or 5 mass % or more and 30 mass % or less. In addition, when the component (c) is contained in 1 mass % or more with respect to all structural units derived from non-crosslinkable structural units of the crosslinked polymer, since the affinity to the electrolytic solution is improved, an effect of improving lithium ion conductivity can be expected. Here, the content of the component (c) in the crosslinked polymer or a salt thereof can be determined from the amount of the monomer prepared when the crosslinked polymer is manufactured.

Examples of (meth)acrylamide derivatives include N-alkoxyalkyl(meth)acrylamide compounds having an alkoxyalkyl group having 5 or more carbon atoms such as N-n-butoxymethyl(meth)acrylamide and N-isobutoxymethyl(meth)acrylamide; and N,N-dialkyl(meth)acrylamide compounds having an alkyl group having 5 or more carbon atoms such as dipentyl(meth)acrylamide and dihexyl(meth)acrylamide, and these may be used alone or two or more thereof may be used in combination.

Examples of nitrile group-containing ethylenically unsaturated monomers include (meth)acrylonitrile; cyanoalkyl (meth)acrylate compounds such as cyanomethyl (meth)acrylate and cyanoethyl (meth)acrylate; cyano group-containing unsaturated aromatic compounds such as 4-cyanostyrene and 4-cyano-α-methylstyrene; and vinylidene cyanide, and these may be used alone or two or more thereof may be used in combination.

Examples of alicyclic structure-containing ethylenically unsaturated monomers include cycloalkyl (meth)acrylates which may have an aliphatic substituent, such as cyclopentyl (meth)acrylate, cyclohexyl (meth)acrylate, methylcyclohexyl (meth)acrylate, t-butylcyclohexyl (meth)acrylate, cyclodecyl(meth)acrylate and cyclododecyl (meth)acrylate; and isobornyl (meth)acrylate, adamantyl (meth)acrylate, dicyclopentenyl(meth)acrylate, dicyclopentenyloxyethyl (meth)acrylate, dicyclopentanyl (meth)acrylate, and cycloalkyl polyalcohol mono(meth)acrylates such as cyclohexanedimethanol mono(meth)acrylate and cyclodecanedimethanol mono(meth)acrylate, and these may be used alone or two or more thereof may be used in combination. Among the above examples, a compound having an acryloyl group as a polymerizable functional group is preferable because it can provide a polymer with a long primary chain length due to its high polymerization speed and favorable binder adhesion.

As other non-ionic ethylenically unsaturated monomers, for example, (meth)acrylate may be used. Examples of (meth)acrylates include alkyl (meth)acrylate compounds such as methyl (meth)acrylate, ethyl (meth)acrylate, butyl (meth)acrylate, isobutyl (meth)acrylate and 2-ethylhexyl (meth)acrylate; aromatic (meth)acrylate compounds such as phenyl (meth)acrylate, phenylmethyl (meth)acrylate, and phenylethyl (meth)acrylate; and alkoxyalkyl (meth)acrylate compounds such as 2-methoxyethyl (meth)acrylate and 2-ethoxyethyl (meth)acrylate, and these may be used alone or two or more thereof may be used in combination. In consideration of adhesion to the active material and cycle properties, an aromatic (meth)acrylate compound can be preferably used. In addition, a compound having an ether bond such as an alkoxyalkyl (meth)acrylate compound is preferable, and 2-methoxyethyl (meth)acrylate is more preferable because the lithium ion conductivity and high-rate properties are further improved.

Among the non-ionic ethylenically unsaturated monomers, a compound having an acryloyl group is preferable because it can provide a polymer with a long primary chain length due to its high polymerization speed and favorable binder adhesion. In addition, as the non-ionic ethylenically unsaturated monomer, a compound having a homopolymer glass transition temperature (Tg) of 0° C. or lower is preferable because the obtained electrode has favorable bending resistance.

### <Forms of Crosslinked Polymer>

The method of crosslinking disclosed in the present specification is not particularly limited, and for example, the forms according to the following method may be exemplified.
1) Copolymerizing of crosslinkable monomers
2) Using chain transfer to polymer chains during radical polymerization
3) After synthesizing a polymer having a reactive functional group, as necessary, adding a crosslinking agent and then performing crosslinking

When a polymer has a crosslinked structure, a binder containing the polymer or a salt thereof can have excellent adhesion. Among the above examples, a method of copolymerizing with crosslinkable monomers is preferable because the operation is simple and it is easy to control the degree of crosslinking.

### <Crosslinkable Monomer>

Examples of crosslinkable monomers include multifunctional polymerizable monomers having two or more polymerizable unsaturated groups and monomers having a self-crosslinking crosslinkable functional group such as a hydrolyzable silyl group.

The multifunctional polymerizable monomers are compounds having two or more polymerizable functional groups such as (meth)acryloyl groups or alkenyl groups in the molecule, and examples include multifunctional (meth)acrylate compounds, multifunctional alkenyl compounds, and compounds having both (meth)acryloyl and alkenyl groups and the like. One of these alone or a combination of two or more may be used. Among these, a multifunctional alkenyl compound is preferable because a uniform crosslinked structure can be easily obtained, and a multifunctional allyl ether compound having two or more allyl ether groups in the molecule may be particularly preferable. In addition, it is preferable for the multifunctional polymerizable monomer to have, for example, a hydroxyl group such as a hydroxyl group derived from a trimethylolpropane framework, in addition to the alkenyl group or allyl group.

Examples of the multifunctional (meth)acrylate compounds include di(meth)acrylates of dihydric alcohols, such as ethylene glycol di(meth)acrylate, propylene glycol di(meth)acrylate, 1,6-hexanediol di(meth)acrylate, polyethylene glycol di(meth)acrylate and polypropylene glycol di(meth)acrylate; poly(meth)acrylates such as tri(meth)acrylates and tetra(meth)acrylates of trihydric and higher polyhydric alcohols, such as trimethylol propane tri(meth)acrylate, trimethylol propane ethylene oxide modified tri(meth)acrylate, glycerin tri(meth)acrylate, pentaerythritol tri(meth)acrylate and pentaerythritol tetra(meth)acrylate; and bisamides such as methylene bisacrylamide, hydroxyethylene bisacrylamide and the like.

Examples of the multifunctional alkenyl compounds include multifunctional allyl ether compounds such as trimethylol propane diallyl ether, trimethylol propane triallyl ether, pentaerythritol diallyl ether, pentaerythritol triallyl ether, tetraallyl oxyethane and polyallyl saccharose; multifunctional allyl compounds such as diallyl phthalate; and multifunctional vinyl compounds such as divinyl benzene and the like.

Examples of the compounds having both (meth)acryloyl and alkenyl groups include allyl(meth)acrylate, isopropenyl(meth)acrylate, butenyl(meth)acrylate, pentenyl(meth)acrylate, 2-(2-vinyloxyethoxy) ethyl (meth)acrylate and the like.

Specific examples of the monomers having self-crosslinking crosslinkable functional groups include vinyl monomers containing hydrolysable silyl groups, and N-methoxyalkyl (meth)acrylamide and the like. One of these alone or a combination of two or more may be used.

A vinyl monomer containing a hydrolysable silyl group is not particularly limited as long as it is a vinyl monomer having at least one hydrolysable silyl group. Examples include vinyl silanes such as vinyl trimethoxysilane, vinyl triethoxysilane, vinyl methyl dimethoxysilane and vinyl dimethyl methoxysilane; acrylic acid esters containing silyl groups, such as trimethoxysilylpropyl acrylate, triethoxysilylpropyl acrylate and methyl dimethoxysilylpropyl acrylate; methacrylic acid esters containing silyl groups, such as trimethoxysilylpropyl methacrylate, triethoxysilylpropyl methacrylate, methyl dimethoxysilylpropyl methacrylate and dimethyl methoxysilylpropyl methacryalte; vinyl ethers containing silyl groups, such as trimethoxysilylpropyl vinyl ether; and vinyl esters containing silyl groups, such as vinyl trimethoxysilyl undecanoate and the like.

When the crosslinked polymer is obtained by crosslinking crosslinkable monomers, the amount of the crosslinkable monomers used with respect to a total amount (total molar amount) of monomers (also referred to as a non-crosslinkable monomer composition) other than the crosslinkable monomer, is preferably, for example, 0.1 mol % or more and 1.0 mol % or less, in some cases. Within this range, a favorable degree of electrode expansion and coating properties are easily obtained. The amount used is more preferably, for example, 0.1 mol % or more and 0.8 mol % or less, for example, 0.2 mol % or more and 0.8 mol % or less, for example, 0.1 mol % or more and 0.7 mol % or less, or for example, 0.2 mol % or more and 0.7 mol % or less.

### <Salt of Crosslinked Polymer>

The acid groups such as carboxyl groups from which ethylenically unsaturated carboxylic acid monomers of the crosslinked polymer are derived may be unneutralized and free, or may be salts in which some or all of the acid groups are neutralized with a base. In the electrode mixture layer composition, the crosslinked polymer is preferably used in the form of a salt in which at least some of the acid groups are neutralized. The type of salt is not particularly limited, and examples thereof include alkali metal salts such as lithium, sodium, and potassium; alkaline earth metal salts such as calcium salts and barium salts; other metal salts such as magnesium salts and aluminum salts; and ammonium salts and organic amine salts. Among these, alkali metal salts such as lithium and magnesium salts are preferable, alkali metal salts are more preferable, and lithium salts are still more preferable because they less negatively influence battery properties.

The degree of neutralization of the crosslinked polymer salt is, for example, 20 mol % or more and 100 mol % or less. The lower limit of the degree of neutralization is, for example, 50 mol %, for example, 60 mol %, for example, 70 mol %, or for example, 80 mol %. The upper limit of the degree of neutralization is, for example, 99 mol %, for example, 95 mol %, or for example, 90 mol %. The range can be a range in which these lower limits and upper limits are appropriately combined, and is preferably, for example, 70 mol % or more and 90 mol % or less, for example, 80 mol % or more and 90 mol % or less, or for example, 90 mol %. When the degree of neutralization is 20 mol % or more, this is preferable because the property of swelling in water is favorable, and the polymer particles are less likely to undergo secondary aggregation (or even if secondary aggregation occurs, the polymer particles are easily disintegrated in an aqueous medium). In this specification, the degree of neutralization can be calculated by computing the preparation amounts of monomers having an acid group such as a carboxyl group and a neutralizing agent used for neutralization. Here, the crosslinked polymer or a salt thereof is dried under depressurization conditions at 80° C. for 3 hours, the powder is then subjected to JR measurement, and the degree of neutralization can be confirmed from the intensity ratio of the peak derived from the C═O group of the carboxylic acid to the peak derived from the C═O group of the carboxylate.

### <Method for Manufacturing Crosslinked Polymer or Salt Thereof>

The crosslinked polymer or a salt thereof can be prepared using known polymerization methods such as solution polymerization, precipitation polymerization, suspension polymerization, and emulsion polymerization, and in consideration of productivity, precipitation polymerization and suspension polymerization (reverse phase suspension polymerization) are preferable. In order to obtain better performance in terms of adhesion and the like, heterogeneous polymerization methods such as precipitation polymerization, suspension polymerization, and emulsion polymerization are preferable, and among these, a precipitation polymerization method is more preferable. The precipitation polymerization is a method for manufacturing polymers by performing a polymerization reaction in a solvent that dissolves raw material unsaturated monomers but does not substantially dissolve the generated polymer. As the polymerization proceeds, the polymer particles become larger according to aggregation and growth, and a dispersion containing polymer particles in which primary particles of several tens of nm to several hundreds of nm undergo secondary aggregation to form particles of several m to several tens of m is obtained. A dispersion stabilizer can be used in order to control the particle size of the polymer. Here, the occurrence of secondary aggregation can be minimized by selecting a dispersion stabilizer, a polymerization solvent and the like. Generally, precipitation polymerization in which the occurrence of secondary aggregation is minimized is also called dispersion polymerization.

In the case of precipitation polymerization, in consideration of the type of monomers used and the like, as the polymerization solvent, it is possible to use a solvent selected from among water and various organic solvents. In order to obtain a polymer with a longer primary chain length, it is preferable to use a solvent having a small chain transfer constant.

The precipitation polymerization or dispersion polymerization is a polymerization method in which polymer chains precipitated from a medium are laminated on the surface of primary particles as the polymerization proceeds. Therefore, in the polymerization reaction, those skilled in the art can appropriately control the particle polymer composition by adding constituent monomers during the polymerization reaction or feeding constituent monomers, and as a result, the degree of swelling in water can be controlled. For example, polymerization of monomers from which the first structural unit is derived and monomers from which the second structural unit is derived may be initiated all at once, or polymerization of only one of monomers may be performed in the initial stage and the other monomers may then be added all at once or added continuously or intermittently in a divided manner to perform polymerization.

Examples of specific polymerization solvents used in the precipitation polymerization and dispersion polymerization include water-soluble solvents such as methanol, t-butyl alcohol, acetone, methyl ethyl ketone, acetonitrile and tetrahydrofuran, as well as benzene, ethyl acetate, dichloroethane, n-hexane, cyclohexane and n-heptane, and these may be used alone or two or more thereof may be used in combination. Alternatively, a mixed solvent of these with water may be used. In this specification, the water-soluble solvent refers to a solvent having a solubility in water at 20° C. of more than 10 g/100 ml. Among the above examples, acetonitrile is preferable because it generates fewer coarse particles, causes weak adhesion to the reactor, and has favorable polymerization stability, the precipitated polymer fine particles are less likely to undergo secondary aggregation (or even if secondary aggregation occurs, the polymer particles are easily disintegrated in an aqueous medium), a polymer having a small chain transfer constant and a large degree of polymerization (primary chain length) is obtained, and the operation during a neutralization step to be described below is easy.

In addition, similarly, in the neutralization step, in order to allow the neutralization reaction to proceed stably and quickly and to adjust the polymerization speed or primary chain length, it is preferable to add a small amount of a highly polar solvent to the polymerization solvent. Such a highly polar solvent is preferably water.

Here, when water is used as a highly polar solvent, the amount of water used (water content) based on a total mass of the polymerization reaction solution is selected in order to improve the polymerization speed and adjust the primary chain length. In the polymerization of highly hydrophilic ethylenically unsaturated carboxylic acid monomers such as acrylic acid, when water is added, the polymerization speed is improved, and a polymer with a long primary chain length is easily obtained. For example, the lower limit of the water content is 3,000 ppm by mass (hereinafter simply referred to as ppm), for example, 3,300 ppm, for example, 4,000 ppm, for example, 5,000 ppm, or for example, 6,000 ppm. In addition, for example, the upper limit of the water content is 15,000 ppm, for example, 12,000 ppm, for example, 10,000 ppm, for example, 9,600 ppm, for example, 8,000 ppm, or for example, 7,000 ppm. The range of the water content can be set by arbitrarily selecting the above lower limit value and upper limit value, and may be, for example, 3,000 ppm or more and 15,000 ppm or less, or for example, 3,000 ppm or more and 9,000 ppm or less.

In the manufacturing of the crosslinked polymer or a salt thereof, a monomer composition in which monomers from which the first structural unit is derived and monomers from which the second structural unit is derived are used at a ratio described above can be used. In addition, the monomer composition can contain crosslinkable monomers in the form already shown.

A high monomer concentration during polymerization is preferable because a polymer with a longer primary chain length is obtained. However, when the monomer concentration is too high, the aggregation of the polymer particles is likely to proceed, it is difficult to control polymerization heat, and there is a risk of the polymerization reaction going out of control. Therefore, for example, in the case of the precipitation polymerization method, the concentration of the monomers in the polymerization reaction solution in the polymerization step is generally in a range of about 2 mass % or more and 40 mass % or less. The concentration lower limit is, for example, 5 mass %, for example, 10 mass %, for example, 15 mass %, for example, 17 mass %, or for example, 20 mass %. In addition, the upper limit is, for example, 40 mass %, for example, 34 mass %, for example, 30 mass %, or for example, 25 mass %. The range of the concentration can be a range in which these lower limits and upper limits are appropriately combined, and is, for example, 10 mass % or more and 30 mass % or less, for example, 15 mass % or more and 30 mass % or less, for example, 16 mass % or more and 30 mass % or less, or for example, 20 mass % or more and 30 mass % or less. Here, in this specification, the “monomer concentration” is a concentration of the total mass of the non-crosslinking monomers used in polymerization relative to the total mass of the reaction solution.

The crosslinked polymer may be manufactured by performing a polymerization reaction in the presence of a base compound. When the polymerization reaction is performed in the presence of a base compound, the polymerization reaction can be stably performed under a high monomer concentration condition. The base compound is a so-called alkaline compound, and either an inorganic base compound or an organic base compound may be used. When the polymerization reaction is performed in the presence of a base compound, the polymerization reaction can be stably performed under a high monomer concentration condition, for example, more than 15 mass %. In addition, since a polymer obtained by polymerization at such a high monomer concentration has a large molecular weight (since it has a large primary chain length), it has excellent adhesion.

Examples of inorganic base compounds as base compounds include alkali metal hydroxides such as lithium hydroxide, sodium hydroxide, and potassium hydroxide, and alkaline earth metal hydroxides such as calcium hydroxide, and magnesium hydroxide, and one or two or more of these can be used. Examples of organic base compounds include ammonia and organic amine compounds, and one or two or more of these can be used. Among these, an organic amine compound is preferable in consideration of polymerization stability and adhesion of the binder containing the obtained crosslinked polymer or a salt thereof.

Examples of organic amine compounds include N-alkyl substituted amines such as monomethylamine, dimethylamine, trimethylamine, monoethylamine, diethylamine, triethylamine, monobutylamine, dibutylamine, tributylamine, monohexylamine, dihexylamine, trihexylamine, trioctylamine and tridodecylamine; (alkyl)alkanolamines such as monoethanolamine, diethanolamine, triethanolamine, propanolamine, dimethylethanolamine and N,N-dimethylethanolamine; cyclic amines such as pyridine, piperidine, piperazine, 1,8-bis(dimethylamino)naphthalene, morpholine and diazabicycloundecene (DBU); and diethylenetriamine and N,N-dimethylbenzylamine, and one or two or more of these can be used. Among these, a hydrophobic amine having a long-chain alkyl group (6 or more and 10 or fewer carbon atoms) such as trioctylamine is preferably used because a larger electrostatic repulsion and steric repulsion are obtained, and thus polymerization stability is easily secured when the monomer concentration is high. Specifically, when the value (C/N) expressed as a ratio of the number of carbon atoms to the number of nitrogen atoms present in the organic amine compound is higher, the polymerization stabilization effect due to the steric repulsion effect is stronger. The C/N value is preferably 3 or more, more preferably 5 or more, still more preferably 10 or more, and yet more preferably 20 or more.

The amount of the base compound used relative to the ethylenically unsaturated carboxylic acid monomers is preferably in a range of 0.001 mol % or more and 4.0 mol % or less. When the amount of the base compound used is within this range, the polymerization reaction can be smoothly performed. The amount used may be 0.05 mol % or more and 4.0 mol % or less, 0.1 mol % or more and 4.0 mol % or less, 0.1 mol % or more and 3.0 mol % or less, or 0.1 mol % or more and 2.0 mol % or less. Here, in this specification, the amount of the base compound used represents the molar concentration of the base compound used relative to the ethylenically unsaturated carboxylic acid monomers, and does not mean the degree of neutralization. That is, the valence of the base compound used is not considered.

A known polymerization initiator such as an azo compound, organic peroxide, inorganic peroxide or the like may be used as the polymerization initiator, without any particular limitations. The conditions of use may be adjusted by a known method such as thermal initiation, redox initiation with a reducing agent, or UV initiation or the like to generate a suitable amount of radicals. In order to obtain a crosslinked polymer with a long primary chain length, it is preferable to set conditions so that the amount of radicals generated is reduced within the allowable range of the manufacturing time.

Examples of the azo compound include 2,2′-azobis(2,4-dimethylvaleronitrile), 2,2′-azobis(N-butyl-2-methylpropionamide), 2-(tert-butylazo)-2-cyanopropane, 2,2′-azobis(2,4,4-trimethylpentane) and 2,2′-azobis(2-methylpropane), and one or two or more of these may be used.

Examples of the organic peroxide include 2,2-bis(4,4-di-t-butylperoxycyclohexyl)propane (“Pertetra A”, hereinafter, product name, manufactured by NOF Corporation), 1,1-di(t-hexylperoxy)cyclohexane (“Perhexa HC”), 1,1-di(t-butylperoxy)cyclohexane (“Perhexa C”), n-butyl-4,4-di(t-butylperoxy)valerate (“Perhexa V”), 2,2-di(t-butylperoxy)butane (“Perhexa 22”), t-butyl hydroperoxide (“Perbutyl H”), cumene hydroperoxide (“Percumyl H”), 1,1,3,3-tetramethylbutyl hydroperoxide (“Perocta H”), t-butylcumyl peroxide (“Perbutyl C”), di-t-butyl peroxide (“Perbutyl D”), di-t-hexyl peroxide (“Perhexyl D”), di(3,5,5-trimethylhexanoyl) peroxide (“Peroyl 355”), dilauroyl peroxide (“Peroyl L”), bis(4-t-butylcyclohexyl) peroxydicarbonate (“Peroyl TCP”), di-2-ethylhexyl peroxydicarbonate (“Peroyl OPP”), di-sec-butyl peroxydicarbonate (“Peroyl SBP”), cumyl peroxyneodecanoate (“Percumyl ND”, hereinafter, product name, manufactured by NOF Corporation), 1,1,3,3-tetramethylbutyl peroxyneodecanoate (“Perocta ND”), t-hexyl peroxyneodecanoate (“Perhexyl ND”), t-butyl peroxyneodecanoate (“Perbutyl ND”), t-butyl peroxyneoheptanoate (“Perbutyl NHP”), t-hexyl peroxypivalate (“Perhexyl PV”), t-butyl peroxypivalate (“Perbutyl PV”), 2,5-dimethyl-2,5-di(2-ethylhexanoyl) hexane (“Perhexa 250”), 1,1,3,3-tetramethylbutyl peroxy-2-ethyl hexanoate, (“Perocta O”), t-hexyl peroxy-2-ethyl hexanoate (“Perhexyl O”), t-butyl peroxy-2-ethyl hexanoate (“Perbutyl O”), t-butyl peroxylaurate (“Perbutyl L”), t-butyl peroxy-3,5,5-trimethylhexanoate (“Perbutyl 355”), t-hexyl peroxyisopropyl monocarbonate (“Perhexyl I”), t-butyl peroxyisopropyl monocarbonate (“Perbutyl I”), t-butyl peroxy-2-ethylhexyl monocarbonate (“Perbutyl E”), t-butyl peroxyacetate (“Perbutyl A”), t-hexyl peroxybenzoate (“Perhexyl Z”) and t-butyl peroxybenzote (“Perbutyl Z”) and the like, and one or two or more of these may be used.

Examples of the inorganic peroxide include potassium persulfate, sodium persulfate, ammonium persulfate and the like. In the case of a redox initiator, sodium sulfite, sodium thiosulfate, sodium formaldehyde sulfoxylate, ascorbic acid, sulfur dioxide gas (SO₂), ferrous sulfate or the like may be used as a reducing agent.

A preferable amount of the polymerization initiator used based on a total amount of 100 parts by mass of the non-crosslinkable monomers used is, for example, 0.001 parts by mass or more and 2 parts by mass or less, for example, 0.005 parts by mass or more and 1 part by mass or less, or for example, 0.01 parts by mass or more and 0.5 parts by mass or less. When the amount of the polymerization initiator used is 0.001 parts by mass or more, the polymerization reaction can be stably performed, and when the amount is 2 parts by mass or less, a polymer with a long primary chain length can be easily obtained.

The polymerization temperature depends on conditions such as the type and concentration of monomers used, and is preferably, for example, 0° C. or higher and 100° C. or lower, preferably, for example, 20° C. or higher and 80° C. or lower, and preferably, for example, 40° C. or higher and 80° C. or lower, for example, 40° C. or higher and 70° C. or lower, or for example, 50° C. or higher and 60° C. or lower. When the polymerization temperature is 20° C. or higher and 80° C. or lower, a crosslinked polymer having an intended particle size and degree of swelling in water is easily obtained. The polymerization temperature may be constant or may vary during the polymerization reaction. In addition, the polymerization time is preferably 1 minute to 20 hours and more preferably 1 hour to 15 hours.

The crosslinked polymer dispersion obtained through the polymerization step is subjected to depressurization and/or heat treatment or the like in the drying step, the solvent is distilled off, and thus a desired crosslinked polymer in a powder form can be obtained. In this case, before the drying step, in order to remove unreacted monomers (and their salts), impurities derived from the initiator and the like, it is preferable to provide a solid-liquid separation step such as centrifugation and filtration and a washing step using water, methanol or the same solvent as the polymerization solvent, continuing the polymerization step. When the washing step is provided, even if the crosslinked polymer undergoes secondary aggregation, it is easily disintegrated when used, the remaining unreacted monomers are additionally removed, and favorable performance is exhibited in terms of adhesion and battery properties.

In this manufacturing method, in the presence of a base compound, a polymerization reaction of a crosslinkable monomer composition containing ethylenically unsaturated carboxylic acid monomers is performed, but an alkaline compound having a base suitable as a crosslinked polymer salt is added to the polymer dispersion obtained through the polymerization step to neutralize the polymer (hereinafter also referred to as a “neutralization step”), and the solvent may then be removed in the drying step. In addition, after a crosslinked polymer powder is obtained without performing the treatment of the neutralization step, when an electrode mixture layer composition is prepared, an alkaline compound may be added to neutralize the polymer (hereinafter also referred to as “post-neutralization”). Among the above examples, the neutralization step is preferable because secondary agglomerates tend to be easily disintegrated.

### <Electrode Mixture Layer Composition>

The electrode mixture layer composition disclosed in this specification contains a binder containing a crosslinked polymer or a salt thereof, an active material and water. The amount of the crosslinked polymer or a salt thereof used in the electrode mixture layer composition based on a total amount of 100 parts by mass of the solid content is, for example, 0.1 parts by mass or more and 20 parts by mass or less. The amount used is, for example, 0.2 parts by mass or more and 10 parts by mass or less, for example, 0.3 parts by mass or more and 8 parts by mass or less, for example, 0.4 parts by mass or more and 5 parts by mass or less, or for example, 0.5 parts by mass or more and 2 parts by mass or less. When the amount of the crosslinked polymer or a salt thereof used is less than 0.1 parts by mass, a sufficient effect of minimizing the degree of electrode expansion, adhesion to the current collector, and favorable coating properties may not be obtained. In addition, the dispersion stability of the active material and the like may be insufficient, and the uniformity of the mixture layer formed may decrease. On the other hand, when the amount of the crosslinked polymer or a salt thereof used is more than 20 parts by mass, the viscosity of the electrode mixture layer composition may increase and coating properties with respect to the current collector may decrease. As a result, there is a risk of bumps and unevenness occurring in the obtained mixture layer and negatively influencing electrode properties. The crosslinked polymer or a salt thereof exhibits a sufficiently high effect of minimizing the degree of electrode expansion even in a small amount (for example, 5 mass % or less) relative to the solid content and it has a carboxy anion, and thus an electrode having low interface resistance and excellent high-rate properties is obtained.

### <Active Material>

Examples of negative electrode active materials include carbon-based materials, lithium metals, lithium alloys and metal oxides, and these may be used alone or two or more thereof may be used in combination. Among these, an active material formed of a carbon-based material such as natural graphite, artificial graphite, hard carbon and soft carbon (hereinafter also referred to as a “carbon-based active material”) is preferable, and graphite such as natural graphite and artificial graphite, and hard carbon are more preferable. In addition, in the case of graphite, spherical graphite is preferably used in terms of battery performance, and the preferable range of the particle size is, for example, 1 to 20 μm, or for example, 5 to 15 μm. In addition, in order to increase the energy density, metals or metal oxides that can absorb lithium, such as silicon and tin, can be used as the negative electrode active material. Among these, silicon has a higher capacity than graphite, and an active material formed of a silicon-based material such as silicon, silicon alloys and silicon oxides such as silicon monoxide (SiO) (hereinafter also referred to as a “silicon-based active material”) can be used. However, although the silicon-based active material has a high capacity, it undergoes a large volume change resulting from charging and discharging. Therefore, it is preferable to use it in combination with the carbon-based active material. In this case, the amount of the silicon active material used based on a total amount of the carbon-based active material and the silicon-based active material is preferably 2 mass % or more and 80 mass % or less. The amount of the silicon-based active material used may be 2 mass % or more and 60 mass % or less, 2 mass % or more and 40 mass % or less, or 2 mass % or more and 10 mass % or less.

Since the carbon-based active material itself has favorable electrical conductivity, it is not necessary to add a conductive assistant. When a conductive assistant is added to further reduce the resistance, the amount of the conductive assistant used based on a total amount of the active material is, for example, 10 mass % or less, or for example, 5 mass % or less, in consideration of the energy density.

As the positive electrode active material, a lithium salt of a transition metal oxide can be used, and for example, layered rock-salt type and spinel type lithium-containing metal oxides can be used. Specific compound examples of layered rock-salt type positive electrode active materials include lithium cobalt oxide, lithium nickel oxide, and ternary systems such as NCM{Li(Niₓ, Co_{y}, Mn_{z}), x+y+z=1} and NCA{Li(Ni_{1-a-b}COₐAl_{b})}. In addition, examples of spinel type positive electrode active materials include lithium manganite. In addition to oxides, phosphate, silicate, sulfur and the like are used, and examples of phosphates include olivine type lithium iron phosphates. As the positive electrode active material, the above materials may be used alone or two or more thereof may be used in combination as a mixture or composite.

Here, when a positive electrode active material containing a layered rock-salt type lithium-containing metal oxide is dispersed in water, lithium ions on the surface of the active material are exchanged with hydrogen ions in water, and thus the dispersion is alkaline. Therefore, there is a risk of an aluminum foil (Al), which is a general current collector material for a positive electrode, being corroded. In such a case, it is preferable to neutralize the alkaline content eluted from the active material using an unneutralized or partially neutralized crosslinked polymer as a binder. In addition, it is preferable to use an amount of the unneutralized or partially neutralized crosslinked polymer at which the amount of unneutralized carboxyl groups in the crosslinked polymer is equivalent to or more than the amount of an alkali eluted from the active material.

Since all positive electrode active materials have low electrical conductivity, they are generally used with a conductive assistant added. Examples of conductive assistants include carbon-based materials such as carbon black, carbon nanotubes, carbon fibers, fine graphite powder, and carbon fibers. Among these, carbon black, carbon nanotubes and carbon fibers are preferable because they make it easy to obtain excellent conductivity. In addition, ketjen black and acetylene black are preferable as carbon black. The conductive assistants may be used alone or two or more thereof may be used in combination. In order to achieve both the conductivity and energy density, the amount of the conductive assistant used based on a total amount of 100 parts by mass of the active material may be, for example, 0.2 to 20 parts by mass, or for example, 0.2 to 10 parts by mass. In addition, as the positive electrode active material, one whose surface is coated with a conductive carbon-based material may be used.

When the electrode mixture layer composition is in a slurry state, the amount of the active material used based on a total amount of the electrode mixture layer composition is, for example, 10 mass % or more and 75 mass % or less. When the amount of the active material used is 10 mass % or more, migration of the binder and the like is curbed. On the other hand, when the amount is 75 mass % or less, it is possible to secure fluidity and coating properties of the electrode mixture layer composition, and a uniform mixture layer can be formed. In addition, the amount of the active material used is, for example, 30 mass % or more, for example, 40 mass % or more, for example, 45 mass % or more, or for example, 50 mass % or more because it is advantageous in terms of the cost of drying media.

The amount of the active material used in the electrode mixture layer composition based on a total amount of 100 parts by mass of the solid content is, for example, 80 parts by mass or more, for example, 85 parts by mass or more, for example, 90 parts by mass or more, or for example, 95 parts by mass or more. In addition, it is, for example, 99 parts by mass or less, for example, 98 parts by mass or less, or for example, 97 parts by mass or less.

In the electrode mixture layer composition, water is used as a medium. In addition, in order to adjust the properties and drying properties of the electrode mixture layer composition, mixed solvents containing lower alcohols such as methanol and ethanol, carbonates such as ethylene carbonate, ketones such as acetone, and water-soluble organic solvents such as tetrahydrofuran and N-methylpyrrolidone may be used. The proportion of water in the mixed medium is, for example, 50 mass % or more, or for example, 70 mass % or more.

When the electrode mixture layer composition is in a coatable slurry state, the content of the water-containing medium in the electrode mixture layer composition is in a range of, for example, 25 mass % or more and 90 mass % or less, or for example, 35 mass % or more and 70 mass % or less, in consideration of coating properties of the slurry, cost of energy required for drying, and productivity.

The binder disclosed in this specification may be composed of only the crosslinked polymer or a salt thereof, and additionally, other binder components such as styrene/butadiene latex (SBR), acrylic latex, polyvinylidene fluoride latex, and cellulose derivatives such as carboxymethyl cellulose (CMC) may be used in combination. When other binder components are used in combination, the amount used may be, for example, 0.1 to 5 mass % or less, or for example, 0.1 to 2 mass % or less, relative to the active material. When the amount of other binder components used is more than 5 mass %, the resistance may increase, and high-rate properties may become insufficient. Among the above examples, the styrene/butadiene latex and/or cellulose derivatives are preferable in consideration of affinity with the crosslinked polymer or a salt thereof and balance between adhesion and bending resistance.

The styrene/butadiene latex is a water-based dispersion of a copolymer having a structural unit derived from an aromatic vinyl monomer such as styrene and a structural unit derived from an aliphatic conjugated diene monomer such as 1,3-butadiene. Examples of aromatic vinyl monomers include α-methylstyrene, vinyl toluene, and divinyl benzene in addition to styrene, and one or two or more of these can be used. The content of the structural units derived from the aromatic vinyl monomers in the copolymer may be in a range of, for example, 20 to 60 mass %, or for example, 30 to 50 mass %, mainly in consideration of adhesion.

Examples of aliphatic conjugated diene monomers include 2-methyl-1,3-butadiene, 2,3-dimethyl-1,3-butadiene, and 2-chloro-1,3-butadiene in addition to 1,3-butadiene, and one or two or more of these can be used. The content of the structural units derived from the aliphatic conjugated diene monomers in the copolymer may be in a range of, for example, 30 to 70 mass %, or for example, 40 to 60 mass %, in consideration of binder adhesion and favorable flexibility of the obtained electrode.

In the styrene/butadiene latex, in addition to the above monomers, in order to further improve performance such as adhesion, as other monomers, nitrile group-containing monomers such as (meth)acrylonitrile, and carboxyl group-containing monomers such as (meth)acrylic acid, itanconic acid, and maleic acid may be used as copolymerization monomers. The content of the structural units derived from the other monomers in the copolymer may be in a range of, for example, 0 to 30 mass % or for example, 0 to 20 mass %.

The electrode mixture layer composition disclosed in this specification contains the above active material, water and binder as essential components, and is obtained by mixing the components using a known means. The method for mixing the components is not particularly limited, and any known method can be used, and a method in which powder components such as an active material, a conductive assistant and crosslinked polymer particles serving as a binder are dried and blended, and are then mixed with a dispersion medium such as water, and dispersed and kneaded is preferable. When the electrode mixture layer composition in a slurry state is obtained, it is preferable to finish the slurry without poor dispersion or aggregation. As the mixing means, known mixers such as a planetary mixer, a thin film rotary mixer and a rotation/revolution mixer can be used, and a thin film rotary mixer is preferably used because a favorable dispersion state is obtained in a short time. In addition, when the thin film rotary mixer is used, it is preferable to perform preliminary dispersion in advance with a stirrer such as a disper.

On the other hand, when the electrode mixture layer composition in a wet powder form is obtained, it is preferable to knead it until it reaches a uniform state without unevenness in concentration using a Henschel mixer, a blender, a planetary mixer, a twin-screw kneader or the like.

### <Secondary Battery Electrode>

The secondary battery electrode disclosed in this specification has a mixture layer formed of the electrode mixture layer composition on the surface of a current collector made of copper or aluminum. The mixture layer is formed by applying the electrode mixture layer composition disclosed in this specification to the surface of the current collector and then drying and removing the medium such as water. The method of applying the electrode mixture layer composition is not particularly limited, and known methods such as a doctor blade method, a dip method, a roll coating method, a comma coating method, a curtain coating method, a gravure coating method and an extrusion method can be used. In addition, the drying can be performed by a known method such as hot air blowing, depressurization, (far) infrared radiation, or microwave irradiation. Generally, the obtained mixture layer after drying is subjected to compression processing using a mold press, a roll press or the like. When compression is performed, the active material and the binder can be adhered, and the strength of the mixture layer and adhesion to the current collector can be improved. According to the compression, the thickness of the mixture layer can be adjusted to, for example, about 30 to 80% of the thickness before compression, and the thickness of the mixture layer after compression is generally about 4 to 200 μm.

A secondary battery can be produced by providing a separator and an electrolytic solution using an organic solvent in the secondary battery electrode disclosed in this specification. The electrolytic solution may be a liquid or a gel. The separator is provided between the positive electrode and the negative electrode of the battery, and has a function of preventing short-circuiting caused by contact between the two electrodes and retaining an electrolytic solution to secure ion conductivity. The separator is preferably a film-like insulating microporous membrane having favorable ion permeability and mechanical strength. As specific materials, polyolefins such as polyethylene and polypropylene, polytetrafluoroethylene and the like can be used.

As the electrolytic solution, any known electrolytic solution that is generally used according to the type of the active material can be used. In lithium-ion secondary batteries, examples of specific solvents include cyclic carbonates having a high dielectric constant and a high electrolyte dissolving ability such as propylene carbonate and ethylene carbonate, and chain carbonates having a low viscosity such as ethyl methyl carbonate, dimethyl carbonate and diethyl carbonate, and these may be used alone or as a mixed solvent. The electrolytic solution is used with a lithium salt such as LiPF₆, LiSbF₆, LiBF₄, LiClO₄, or LiAlO₄ dissolved in this solvent. In nickel hydride secondary batteries, a potassium hydroxide aqueous solution can be used as the electrolytic solution. The secondary battery is obtained by forming a positive electrode plate and a negative electrode plate separated by a separator in a spiral or laminated structure and housing them in a case or the like.

As described above, the binder disclosed in this specification exhibits excellent adhesion and conformability with respect to the active material in the mixture layer. Therefore, a secondary battery including an electrode obtained using the binder can secure favorable integrity and minimize the degree of electrode expansion even when charging and discharging are repeated. As a result, this can contribute to favorable cycle properties. In addition, it is also useful for the use of a silicon-containing active material having a large expansion and contraction rate, and is expected to contribute to increasing the capacity of the battery. Particularly, it is suitable for a vehicle secondary battery and the like. In addition, even under a high active material concentration condition, the coating properties of the electrode mixture layer composition (electrode slurry) can be improved. Therefore, this is advantageous in that drying energy when the mixture layer is formed is reduced and the productivity is improved. Therefore, the binder disclosed in this specification can be particularly preferably used in a non-aqueous electrolyte secondary battery electrode, and particularly useful for a non-aqueous electrolyte lithium-ion secondary battery having a high energy density.

### EXAMPLES

The present invention is explained below based on examples. The description of the present disclosure is not limited to these examples. “Parts” and “percentage” values below represent mass parts and mass percentages unless otherwise specified.

In the following examples, a carboxyl group-containing crosslinked polymer or a salt thereof was evaluated by the following method.

### <Method of Evaluating Carboxyl Group-Containing Crosslinked Polymer or Salt Thereof>

### [Measurement of Particle Size (Particle Size Before Swelling) in Acetonitrile Medium]

1.0 g of a powder of a carboxyl group-containing crosslinked polymer or a salt thereof and 5.0 g of acetonitrile (99.5 mass % or more) were weighed out in a 20 cc container, and ultrasonic waves were emitted using an ultrasonic homogenizer (LUH150, commercially available from Yamato Scientific Co., Ltd.) at an output of 25 W for 30 seconds to obtain a dispersion. Next, the particle size distribution of the dispersion was measured using a laser diffraction/scattering particle size distribution analyzer (Microtrac MT-3300EXII, commercially available from Microtrac Corporation) using acetonitrile as a dispersion medium. 0.05 mL of the dispersion was added to an excessive amount of the dispersion medium that was circulating, and an appropriate scattered light intensity was obtained. Then, once the particle size distribution shape was confirmed to be stable a few minutes later, the particle size distribution was measured and a volume-based median diameter (D50) was obtained as a representative value of the particle size.

### [Degree of Swelling in Water at pH 8]

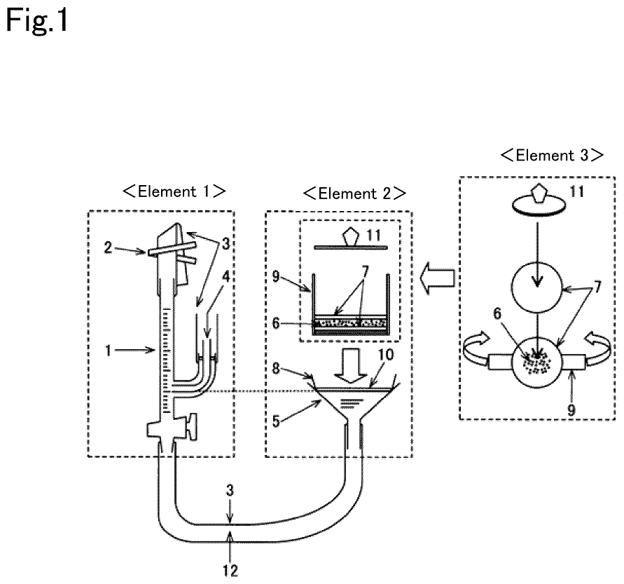

The degree of swelling in water at pH 8 is expressed as a ratio of the mass of the sample when swollen in water to the dry mass of the sample. The degree of swelling in water was measured by the following method. The measurement device is shown in FIG. 1.

The measurement device was composed of <Element 1> to <Element 3> in FIG. 1.
<Element 1> composed of a burette 1 with a branch pipe for venting air, a pinch cock 2, a silicone tube 3 and a polytetrafluoroethylene tube 4.
<Element 2> on a funnel 5, a support cylinder 8 with many holes in the bottom was provided, and a device filter paper 10 was additionally placed thereon.
<Element 3> a sample 6 (measurement sample) of a crosslinked polymer or a salt thereof was interposed between two sheets of sample fixing filter paper 7, and the sample fixing filter paper 7 was fixed with an adhesive tape 9. Here, all the filter paper sheets used were ADVANTEC No. 2 (an inner diameter of 55 mm).
   <Element 1> and <Element 2> were Connected by the Silicone Tube 3.

In addition, the funnel 5 and the support cylinder 8 were fixed in height relative to the burette 1, and were set so that the lower end of the polytetrafluoroethylene tube 4 placed inside the burette branch pipe and the bottom of the support cylinder 8 were at the same height (dotted line in FIG. 1).

Next, the measurement method will be described.
(1) The pinch cock 2 in <Element 1> was removed, and ion-exchanged water (pH 8) was poured from the top of the burette 1 through the silicone tube 3 so that the burette 1 and the device filter paper 10 were filled with ion-exchanged water 12. Next, the pinch cock 2 was closed to remove air from the polytetrafluoroethylene tube 4 connected to the burette branch pipe with a rubber stopper. Therefore, the ion-exchanged water 12 was continuously supplied from the burette 1 to the device filter paper 10.
(2) Next, the excess ion-exchanged water 12 exuded from the device filter paper 10 was removed, and the reading (a) of the scale on the burette 1 was then recorded.
(3) 0.1 to 0.2 g of the measurement sample powder was weighed out, and uniformly placed at the center of sample fixing filter paper 7, as described in <Element 3>. The sample was inserted into another sheet of filter paper, two sheets of filter paper were secured with the adhesive tape 9, and the sample was fixed. The filter paper on which the sample was fixed was placed on the device filter paper 10 shown in <Element 2>.
(4) Next, the reading (b) of the scale on the burette 1 was recorded 30 minutes after a lid 11 was placed on the device filter paper 10.
(5) A total amount (c) of the amount of water absorption of the measurement sample and the amount of water absorption of two sheets of sample fixing filter paper 7 was calculated by (a−b). By the same operation, the amount of water absorption (d) of only the two sheets of filter paper 7, containing no sample of the crosslinked polymer or a salt thereof was measured.
(6) The operation was performed, and the degree of swelling in water was computed by the following formula. Here, the solid content used in the computation was a value measured by the method to be described below. The formula was the same as the above Computation Formula (2).

$$Degree of swelling in water = \{ dry weight ( g ) of measurement sample + ( c - d ) \} / \{ dry weight ( g ) of measurement sample \}$$

Here, dry weight (g) of measurement sample=weight (g) of measurement sample×(solid content (%)/100)

Here, the method for measuring the solid content will be described below.

About 0.5 g of the sample was placed in a weighing bottle whose weight was measured in advance [weight of weighing bottle=B(g)], the weighing bottle was accurately weighed out [W₀(g)], the sample was then accommodated in a windless dryer together with the weighing bottle and dried at 155° C. for 45 minutes, the weight of the weighing bottle at that time was measured [W₁(g)], and the solid content was calculated by the following formula.

$$Solid content ( \% ) = ( {W}_{1} - B ) / ( {W}_{0} - B ) \times 100$$

### <Manufacture of Carboxyl Group-Containing Crosslinked Polymer Salt>

### Manufacturing Example 1: Manufacture of Carboxyl Group-Containing Crosslinked Polymer Salt R-1

For polymerization, a reactor including a stirring blade, a thermometer, a reflux condenser and a nitrogen introduction pipe was used.

395 parts of acetonitrile, 1.63 parts of ion-exchanged water, 99.9 parts of acrylic acid (hereinafter referred to as “AA”), 0.1 parts of acryloyl morpholine, 0.6 parts of trimethylolpropane diallyl ether (product name “NEOALLYL T-20,” commercially available from Osaka Soda Co., Ltd.) and trioctylamine (TOA) equivalent to 1.0 mol % based on the AA were put into the reactor. The inside of the reactor was thoroughly purged with nitrogen, and the internal temperature was then raised to 55° C. by heating. After the internal temperature was confirmed to be stable at 55° C., when 0.040 parts of 2,2′-azobis(2,4-dimethylvaleronitrile) (product name “V-65,” commercially available from FUJIFILM Wako Pure Chemical Corporation) was added as a polymerization initiator, since white turbidity was observed in the reaction solution, this point was determined as a polymerization initiation point. Here, the concentration of the monomers was calculated to be 20%. The polymerization reaction was continued while maintaining the internal temperature at 50° C. by adjusting the external temperature (water bath temperature), cooling of the reaction solution started 12 hours after the polymerization initiation point, the internal temperature was decreased to 25° C., and 52.4 parts of a lithium hydroxide-monohydrate (hereinafter also referred to as “LiOH·H₂O”) powder was then added. After the addition, stirring was continued at room temperature for 12 hours to obtain a slurry-like polymerization reaction solution in which carboxyl group-containing crosslinked polymer salt (hereinafter simply also referred to as crosslinked polymer salt) R-1 (Li salt, a degree of neutralization of 90 mol %) particles were dispersed in a medium.

The obtained polymerization reaction solution was centrifuged to precipitate the polymer, and the supernatant was then removed. Then, the precipitate was re-dispersed in acetonitrile with the same weight as the polymerization reaction solution, and a washing operation of precipitating polymer particles by centrifugation and removing the supernatant was then repeated twice. The precipitate was collected and dried at 80° C. for 3 hours under depressurization conditions, and volatile components were removed to obtain a powder of a crosslinked polymer salt R-1 having a carboxyl group. Since the crosslinked polymer salt R-1 was hygroscopic, it was sealed and stored in a container having water vapor barrier properties. Here, the crosslinked polymer salt R-1 powder was subjected to IR measurement, and the degree of neutralization was calculated from the intensity ratio of the peak derived from the C═O group of the carboxylic acid to the peak derived from the C═O group of carboxylic acid lithium, and was determined to be 90 mol %, which was equal to the computed value from the amount prepared. In addition, the particle size in the acetonitrile medium was 0.68 μm, and the degree of swelling in water at pH 8 was 25.5.

### Manufacturing Examples 2 to 18 and Comparative Manufacturing Examples 1 to 4: Manufacture of Crosslinked Polymer Salts R-2 to R-22

The same operation as in Manufacturing Example 1 was performed to obtain polymerization reaction solutions containing crosslinked polymer salts R-2 to R-22, except that the amounts of raw materials prepared and the polymerization temperature were changed as shown in Table 1. Next, the same operation as in Manufacturing Example 1 was performed on each polymerization reaction solution to obtain powder-like crosslinked polymer salts R-2 to R-22. Each crosslinked polymer salt was sealed and stored in a container having water vapor barrier properties. The physical property values of the obtained crosslinked polymer salts were measured in the same manner as in Manufacturing Example 1 and are shown in Table 1.

TABLE 1

| | | | Manufacturing Example/Comparative | | | | | |
|---|---|---|---|---|---|---|---|---|
| | | | Manufacturing Example No. | | | | | |
| | | | Manufacturing Example | | | | | |
| | | | 1 | 2 | 3 | 4 | 5 | 6 |
| | | | Carboxyl group-containing crosslinked polymer salt | | | | | |
| | | | R-1 | R-2 | R-3 | R-4 | R-5 | R-6 |
| Preparation | Carboxyl | AA | 99.9 | 99 | 98 | 80 | 70 | 99 |
| [parts] | group-containing | | | | | | | |
| | monomer | | | | | | | |
| | Nitrogen- | ACMO | 0.1 | 1.0 | 2.0 | 20 | 30 | |
| | containing | DMAAm | | | | | | 1.0 |
| | monomer | HEAAm | | | | | | |
| | Crosslinkable | T-20 | 0.20 | 0.20 | 0.20 | 0.20 | 0.20 | 0.20 |
| | monomer [mol %] | TMPTA | | | | | | |
| | Base compound | TOA | 1.0 | 1.0 | 1.0 | 1.0 | 1.0 | 1.0 |
| | [mol %] | | | | | | | |
| | Polymerization | Ion-exchanged | 1.65 | 1.65 | 1.65 | 1.65 | 1.65 | 1.65 |
| | solvent | water | | | | | | |
| | | AcN | 395 | 395 | 395 | 395 | 395 | 395 |
| | | MeOH | | | | | | |
| | Polymerization | V-65 | 0.03 | 0.03 | 0.03 | 0.03 | 0.03 | 0.03 |
| | initiator | | | | | | | |
| | Neutralization | LiOH•H₂O | 52.4 | 51.9 | 51.4 | 41.9 | 36.7 | 51.9 |
| | step | K₂CO₃ | | | | | | |

| Initial monomer concentration [wt %] | | 20% | 20% | 20% | 20% | 20% | 20% |
|---|---|---|---|---|---|---|---|
| Water content [ppm] | | 3300 | 3300 | 3300 | 3300 | 3300 | 3300 |
| Polymerization temperature [° C.] | | 50 | 50 | 50 | 50 | 50 | 50 |
| Neutralizing | Type | Li | Li | Li | Li | Li | Li |
| salt | Degree of neutralization [mol %] | 90.0% | 90.0% | 90.0% | 90.0% | 90.0% | 90.0% |

| | | | | | | |
|---|---|---|---|---|---|---|
| Particle size in acetonitrile medium [μm] | 0.68 | 0.76 | 0.89 | 0.95 | 0.99 | 0.76 |
| Degree of swelling in water at pH 8 | 25.5 | 29.2 | 34.6 | 36.8 | 38.7 | 28.5 |

| | | | Manufacturing Example/Comparative | | | | |
|---|---|---|---|---|---|---|---|
| | | | Manufacturing Example No. | | | | |
| | | | Manufacturing Example | | | | |
| | | | 7 | 8 | 9 | 10 | 11 |
| | | | Carboxyl group-containing crosslinked polymer salt | | | | |
| | | | R-7 | R-8 | R-9 | R-10 | R-11 |
| Preparation | Carboxyl | AA | 99 | 99 | 99 | 99 | 99 |
| [parts] | group-containing | | | | | | |
| | monomer | | | | | | |
| | Nitrogen- | ACMO | | 1.0 | 1.0 | 1.0 | 1.0 |
| | containing | DMAAm | | | | | |
| | monomer | HEAAm | 1.0 | | | | |
| | Crosslinkable | T-20 | 0.20 | | 0.30 | 0.67 | 0.20 |
| | monomer [mol %] | TMPTA | | 0.1 | | | |
| | Base compound | TOA | 1.0 | 1.0 | 1.0 | 1.0 | 1.0 |
| | [mol %] | | | | | | |
| | Polymerization | Ion-exchanged | 1.65 | 1.65 | 1.65 | 1.66 | 1.95 |
| | solvent | water | | | | | |
| | | AcN | 395 | 395 | 395 | 395 | 485 |
| | | MeOH | | | | | |
| | Polymerization | V-65 | 0.03 | 0.03 | 0.03 | 0.03 | 0.03 |
| | initiator | | | | | | |
| | Neutralization | LiOH•H₂O | 51.9 | 51.9 | 51.9 | 51.9 | 51.9 |
| | step | K₂CO₃ | | | | | |

| Initial monomer concentration [wt %] | | 20% | 20% | 20% | 20% | 17% |
|---|---|---|---|---|---|---|
| Water content [ppm] | | 3300 | 3300 | 3300 | 3300 | 3300 |
| Polymerization temperature [° C.] | | 50 | 50 | 50 | 50 | 50 |
| Neutralizing | Type | Li | Li | Li | Li | Li |
| salt | Degree of neutralization [mol %] | 90.0% | 90.0% | 90.0% | 90.0% | 90.0% |

| | | | | | |
|---|---|---|---|---|---|
| Particle size in acetonitrile medium [μm] | 0.77 | 0.89 | 0.75 | 0.74 | 0.66 |
| Degree of swelling in water at pH 8 | 28.9 | 27.5 | 27.9 | 25.1 | 31.2 |

| | | | Manufacturing Example/Comparative | | | | | | |
|---|---|---|---|---|---|---|---|---|---|
| | | | Manufacturing Example No. | | | | | | |
| | | | Manufacturing Example | | | | | | |
| | | | 12 | 13 | 14 | 15 | 16 | 17 | 18 |
| | | | Carboxyl group-containing crosslinked polymer salt | | | | | | |
| | | | R-12 | R-13 | R-14 | R-15 | R-16 | R-17 | R-18 |
| Preparation | Carboxyl | AA | 99 | 99 | 99 | 99 | 99 | 99 | 99 |
| [parts] | group-containing | | | | | | | | |
| | monomer | | | | | | | | |
| | Nitrogen- | ACMO | 1.0 | 1.0 | 1.0 | 1.0 | 1.0 | 1.0 | 1.0 |
| | containing | DMAAm | | | | | | | |
| | monomer | HEAAm | | | | | | | |
| | Crosslinkable | T-20 | 0.20 | 0.20 | 0.20 | 0.20 | 0.20 | 0.20 | 0.20 |
| | monomer [mol %] | TMPTA | | | | | | | |
| | Base compound | TOA | 1.0 | 1.0 | 1.0 | 1.0 | 1.0 | 1.0 | 1.0 |
| | [mol %] | | | | | | | | |
| | Polymerization | Ion-exchanged | 1.33 | 1.65 | 1.65 | 1.65 | 1.65 | 4.80 | 1.65 |
| | solvent | water | | | | | | | |
| | | AcN | 298 | 395 | 395 | 395 | 395 | 395 | 395 |
| | | MeOH | | | | | | | |
| | Polymerization | V-65 | 0.03 | 0.12 | 0.40 | 0.03 | 0.03 | 0.02 | 0.01 |
| | initiator | | | | | | | | |
| | Neutralization | LiOH•H₂O | 51.9 | 51.9 | 51.9 | 40.4 | | 51.9 | 51.9 |
| | step | K₂CO₃ | | | | | 85.0 | | |

| Initial monomer concentration [wt %] | | 25% | 20% | 20% | 20% | 20% | 20% | 20% |
|---|---|---|---|---|---|---|---|---|
| Water content [ppm] | | 3300 | 3300 | 3300 | 3300 | 3300 | 9600 | 3300 |
| Polymerization temperature [° C.] | | 50 | 50 | 50 | 50 | 50 | 50 | 80 |
| Neutralizing | Type | Li | Li | Li | Li | K | Li | Li |
| salt | Degree of neutralization [mol %] | 90.0% | 90.0% | 90.0% | 70.0% | 90.0% | 90.0% | 90.0% |

| | | | | | | | |
|---|---|---|---|---|---|---|---|
| Particle size in acetonitrile medium [μm] | 0.91 | 0.71 | 0.62 | 0.75 | 0.75 | 0.71 | 0.73 |
| Degree of swelling in water at pH 8 | 38.5 | 32.1 | 36.8 | 29.5 | 30.2 | 29.8 | 31.2 |

| | | | Manufacturing Example/Comparative | | | |
|---|---|---|---|---|---|---|
| | | | Manufacturing Example No. | | | |
| | | | Comparative Manufacturing Example | | | |
| | | | 1 | 2 | 3 | 4 |
| | | | Carboxyl group-containing crosslinked polymer salt | | | |
| | | | R-19 | R-20 | R-21 | R-22 |
| Preparation | Carboxyl | AA | 99 | 99 | 99 | 99 |
| [parts] | group-containing | | | | | |
| | monomer | | | | | |
| | Nitrogen- | ACMO | 1.0 | 1.0 | 1.0 | 1.0 |
| | containing | DMAAm | | | | |
| | monomer | HEAAm | | | | |
| | Crosslinkable | T-20 | 0.20 | 0.07 | 0.20 | 0.40 |
| | monomer [mol %] | TMPTA | | | | |
| | Base compound | TOA | 1.0 | 1.0 | 1.0 | 1.0 |
| | [mol %] | | | | | |
| | Polymerization | Ion-exchanged | 0.95 | 0.95 | 3.30 | 3.30 |
| | solvent | water | | | | |
| | | AcN | 152 | 182 | 895 | 865 |
| | | MeOH | 30 | | | 30 |
| | Polymerization | V-65 | 0.03 | 0.03 | 0.80 | 0.03 |
| | initiator | | | | | |
| | Neutralization | LiOH•H₂O | 51.9 | 51.9 | 51.9 | 51.9 |
| | step | K₂CO₃ | | | | |

| Initial monomer concentration [wt %] | | 35% | 35% | 10% | 10% |
|---|---|---|---|---|---|
| Water content [ppm] | | 3300 | 3300 | 3300 | 3300 |
| Polymerization temperature [° C.] | | 50 | 50 | 50 | 50 |
| Neutralizing | Type | Li | Li | Li | Li |
| salt | Degree of neutralization [mol %] | 90.0% | 90.0% | 90.0% | 90.0% |

| | | | | |
|---|---|---|---|---|
| Particle size in acetonitrile medium [μm] | 1.80 | 0.72 | 0.50 | 0.71 |
| Degree of swelling in water at pH 8 | 30.1 | 55.0 | 32.1 | 20.1 |

The details of compounds used in Table 1 are shown below.
AA: acrylic acid
ACMO: acroylmorpholine
DMAAm: N,N-dimethylacrylamide
HEAAm: 2-hydroxyethylacrylamide
T-20: trimethylolpropane diallyl ether (product name “NEOALLYL T-20,” commercially available from Osaka Soda Co., Ltd.)
TMPTA: trimethylolpropane triacrylate (product name “ARONIX (registered trademark) M-309,” commercially available from Toagosei Co., Ltd.)
TOA: trioctylamine
AcN: acetonitrile
MeOH: methanol
V-65: 2,2′-azobis(2,4-dimethylvaleronitrile) (commercially available from FUJIFILM Wako Pure Chemical Corporation)
LiOH·H₂O: lithium hydroxide monohydrate
K₂CO₃: potassium carbonate

### <Evaluation of Crosslinked Polymer Salts R-1 to R-22 as Binders>

Next, the produced crosslinked polymer salts R-1 to R-22 (R-1 to R-18: Manufacturing Examples, and R-19 to R-22: Comparative Manufacturing Examples) were evaluated as binders for secondary battery electrodes. By the following method, the crosslinked polymer salts R-1 to R-18 and R-19 to R-22 were used to prepare electrode mixture layer compositions of Examples 1 to 18 and Comparative Examples 1 to 4, negative electrodes were produced using the compositions, and coating properties were evaluated. In addition, secondary batteries were produced together with the negative electrodes and the electrolytic solutions, and the degree of electrode expansion and cycle properties were evaluated. The results are shown in Table 2. An overall evaluation was also performed in terms of the coating properties, the cycle properties and the degree of electrode expansion. Here, more A's in the overall evaluation AAA, AA, A, B and C indicate better results, and letters later in alphabetical order indicate worse results. AAA, AA, A, B and C indicate “very excellent,” “excellent,” “slightly excellent,” “good,” and “poor,” respectively.

### (Preparation of Electrode Mixture Layer Composition)

A mixture of each crosslinked polymer salt, styrene/butadiene rubber (SBR) and sodium carboxymethyl cellulose (CMC) was used as a binder, and artificial graphite (product name “SCMG-CF,” commercially available from SHOWA DENKO K.K.), and a Si-based active material (SiO 5 μm, commercially available from Osaka Titanium Technologies Co., Ltd.) were used as active materials.

Using a planetary mixer (HIVIS MIX 2P-03 model, commercially available from Primix Corporation), ion-exchanged water was used as a diluent solvent so that the solid content concentration of the electrode mixture layer composition was 53 mass %, the artificial graphite:the Si-based active material:the crosslinked polymer salt R-1:SBR:CMC were added at a mass ratio of 92.15:4.85:1:1:1 (solid content) and mixed for 1 hour and 30 minutes to prepare an electrode mixture layer composition in a slurry state (electrode slurry).

### (Production of Negative Electrode Plate and Evaluation of Coating Properties)

Next, the electrode slurry was applied onto a current collector (copper foil) with a thickness of 20 μm using an adjustable applicator, and dried in a ventilation dryer at 100° C. for 15 minutes to form a mixture layer. Then, rolling was performed so that the thickness (hereinafter referred to as “T₁”) of the mixture layer was 50±5 μm, and the mixture density was 1.70±0.20 g/cm³, and the sample was then punched out to a 3 cm square to obtain a negative electrode plate.

The appearance of the obtained mixture layer was visually observed, the coating properties were evaluated based on the following criteria, and the result was determined as “A.”

### <Criteria for Determining Coating Properties>

A: no abnormal appearance such as streaks and bumps was observed on the surface.
B: slight abnormal appearance such as streaks and bumps was observed on the surface.
C: significant abnormal appearance such as streaks and bumps was observed on the surface.

### (Production of Positive Electrode Plate)

In an N-methylpyrrolidone (NMP) solvent, 100 parts of LiNi_{0.5}Co_{0.2}Mn_{0.3}O₂(NCM) as a positive electrode active material and 2 parts of acetylene black were mixed and added, and 4 parts of polyvinylidene fluoride (PVDF) as an electrode composition binder was mixed to prepare a positive electrode composition. The positive electrode composition was applied to an aluminum current collector (thickness: 20 μm) and dried to form a mixture layer. Then, rolling was performed so that the thickness of the mixture layer was 125 μm, and the mixture density was 3.0 g/cm³, and the sample was then punched out to a 3 cm square to obtain a positive electrode plate.

### (Preparation of Electrolytic Solution)

1 mass % of vinylene carbonate (VC) and 2 mass % of fluoroethylene carbonate (FEC) were added to a mixed solvent containing ethylene carbonate (EC) and dimethyl carbonate (DMC) (at a volume ratio of EC:DMC═3:7), and LiPF₆ was dissolved at 1.2 mol/L to prepare a non-aqueous electrolyte.

### (Production of Secondary Battery)

A battery was formed by attaching lead terminals to positive and negative electrodes, placing the electrodes facing each other with a separator (made of polyethylene: a film thickness of 16 μm, a porosity of 47%) therebetween in an aluminum laminate battery exterior body, and performing liquid injection and sealing, and thereby a test battery was prepared. Here, the design capacity of this prototype battery was 50 mAh. Regarding the design capacity of the battery, the design was performed based on a charge cut-off voltage of up to 4.2 V.

### (Evaluation of Cycle Properties)

The lithium-ion secondary battery of the laminated cell produced above was subjected to a charging and discharging operation at a charging and discharging rate of 0.1C under conditions of CC discharging from 2.5 to 4.2 V in an environment at 45° C., and the initial capacity C₀ was measured. In addition, charging and discharging were repeated at a charging and discharging rate of 0.5C under conditions of CC discharging from 2.5 to 4.2 V in an environment at 25° C., and the capacity C₅₀ after 50 cycles was measured. The cycle property (ΔC) was calculated by the following formula. A higher ΔC value indicates better cycle properties.

$$Δ C = {C}_{50} / {C}_{0} \times 100 ( \% )$$

### (Measurement of Degree of Electrode Expansion)

After charging and discharging as specified in the evaluation of cycle properties above were performed for 50 cycles, the battery was charged again and then disassembled, and the thickness (hereinafter referred to as “T₂”) of the mixture layer of the negative electrode plate was measured. Here, T₁ is the initial thickness of the mixture layer.

$$Degree of electrode expansion = ( {T}_{2} - {T}_{1} ) / {T}_{1} \times 100 ( \% )$$

TABLE 2

| | | | | Example and Comparative Example No. | | | | | | | | | | |
|---|---|---|---|---|---|---|---|---|---|---|---|---|---|---|
| | | | | Example | | | | | | | | | | |
| | | | | 1 | 2 | 3 | 4 | 5 | 6 | 7 | 8 | 9 | 10 | 11 |
| Electrode | Active | Artificial graphite | | 92.15 | 92.15 | 92.15 | 92.15 | 92.15 | 92.15 | 92.15 | 92.15 | 92.15 | 92.15 | 92.15 |
| mixture layer | material | Si-based active material | | 4.85 | 4.85 | 4.85 | 4.85 | 4.85 | 4.85 | 4.85 | 4.85 | 4.85 | 4.85 | 4.85 |
| composition | Binder | Carboxyl | Type | R-1 | R-2 | R-3 | R-4 | R-5 | R-6 | R-7 | R-8 | R-9 | R-10 | R-11 |
| | | group-containing | Parts | 1 | 1 | 1 | 1 | 1 | 1 | 1 | 1 | 1 | 1 | 1 |
| | | crosslinked | | | | | | | | | | | | |
| | | polymer salt | | | | | | | | | | | | |
| | | SBR | | 1 | 1 | 1 | 1 | 1 | 1 | 1 | 1 | 1 | 1 | 1 |
| | | CMC | | 1 | 1 | 1 | 1 | 1 | 1 | 1 | 1 | 1 | 1 | 1 |
| Evaluation | Coating properties | | | A | A | A | A | B | A | A | A | A | A | A |
| results | Cycle properties | | | 86.5 | 87.0 | 87.0 | 86.5 | 86.6 | 86.6 | 86.5 | 87.0 | 85.0 | 86.0 | 87.0 |
| | Degree of electrode expansion | | | 36 | 31 | 33 | 34 | 38 | 33 | 34 | 36 | 35 | 37 | 39 |
| Overall evaluation | | | | AA | AAA | AAA | AAA | A | AAA | AAA | AA | AAA | AA | A |
| | | | | Example and Comparative Example No. | | | | | | | | | | |
| | | | | Example | | | | | | | Comparative Example | | | |
| | | | | 12 | 13 | 14 | 15 | 16 | 17 | 18 | 1 | 2 | 3 | 4 |
| Electrode | Active | Artificial graphite | | 92.15 | 92.15 | 92.15 | 92.15 | 92.15 | 92.15 | 92.15 | 92.15 | 92.15 | 92.15 | 92.15 |
| mixture layer | material | Si-based active material | | 4.85 | 4.85 | 4.85 | 4.85 | 4.85 | 4.85 | 4.85 | 4.85 | 4.85 | 4.85 | 4.85 |
| composition | Binder | Carboxyl | Type | R-12 | R-13 | R-14 | R-15 | R-16 | R-17 | R-18 | R-19 | R-20 | R-21 | R-22 |
| | | group-containing | Parts | 1 | 1 | 1 | 1 | 1 | 1 | 1 | 1 | 1 | 1 | 1 |
| | | crosslinked | | | | | | | | | | | | |
| | | polymer salt | | | | | | | | | | | | |

| | | | | | | | | | | | |
|---|---|---|---|---|---|---|---|---|---|---|---|
| SBR | 1 | 1 | 1 | 1 | 1 | 1 | 1 | 1 | 1 | 1 | 1 |
| CMC | 1 | 1 | 1 | 1 | 1 | 1 | 1 | 1 | 1 | 1 | 1 |

| | | | | | | | | | | | | |
|---|---|---|---|---|---|---|---|---|---|---|---|---|
| Evaluation | Coating properties | A | A | B | A | A | B | B | B | C | B | A |
| results | Cycle properties | 87.0 | 85.0 | 85.0 | 84.0 | 84.0 | 85.0 | 83.0 | 78.0 | 81.0 | 87.0 | 85.0 |
| | Degree of electrode expansion | 38 | 37 | 38 | 38 | 38 | 39 | 39 | 42 | 40 | 41 | 41 |

| | | | | | | | | | | | |
|---|---|---|---|---|---|---|---|---|---|---|---|
| Overall evaluation | A | A | A | A | A | A | B | C | C | C | C |

The details of compounds newly used in Table 2 are shown below.
CMC: sodium carboxymethyl cellulose
SBR: styrene butadiene rubber

### Evaluation Results

As can be clearly understood from the results of Examples 1 to 18, the binder could minimize the degree of electrode expansion and allowed the electrode slurry to exhibit excellent cycle properties and excellent coating properties. Among them, the crosslinked polymer salts having a particle size in an acetonitrile medium and a degree of swelling in water at pH 8 that were, respectively, 0.75 to 0.95 μm and 27.9 to 36.8 (Examples 2 to 4, 6 to 7, and 9), 0.76 to 0.95 m and 28.5 to 36.8 (Examples 2 to 4, and 6 to 7), and 0.76 to 0.95 μm and 29.2 to 36.8 (Examples 2 to 4) were excellent in minimizing electrode expansion.

Regarding this, when the particle size in an acetonitrile medium and the degree of swelling in water at pH 8 increased, the probability of binding within the active material increased, and binding properties were improved, but when the particle size was too large, the number of crosslinked polymer salt molecules per unit mass decreased, and the number of binding points decreased, and when the degree of swelling in water was too large, the mechanical properties of the crosslinked polymer salt deteriorated, and an optimum point was speculated to be present between the particle size and the degree of swelling in water.

Further, focusing on the type of nitrogen-containing ethylenically unsaturated monomers, the results showed that acryloyl morpholine (Example 2) was particularly excellent in the effect of minimizing the degree of electrode expansion compared to other ethylenically unsaturated monomers (Examples 6 and 7). In addition, it was also found that, regarding the crosslinked polymer salt, the lithium salt had a better electrode expansion degree minimizing ability than the potassium salt (Examples 2 and 16), and when the degree of neutralization of the lithium salt was 90 mol %, the electrode expansion degree minimizing ability was better than when the degree of neutralization was 70 mol % (Examples 2 and 15).

On the other hand, the binders for non-aqueous electrolyte secondary battery electrodes (Comparative Examples 1 to 4) having a particle size in an acetonitrile medium outside 0.60 m or more and 1.0 μm or less or a degree of swelling in water at pH 8 outside 25 or more and 40 or less had a significantly inferior effect of minimizing the degree of electrode expansion.

### INDUSTRIAL APPLICABILITY

The binder disclosed in this specification can be particularly preferably used in a non-aqueous electrolyte secondary battery electrode, and particularly useful for a non-aqueous electrolyte lithium-ion secondary battery having a high energy density. Therefore, the binder can be preferably used in various applications including electric vehicles in which compact secondary batteries are required.

1. A binder for non-aqueous electrolyte secondary battery electrodes, including a crosslinked polymer having a carboxyl group or a salt thereof,
wherein the crosslinked polymer or a salt thereof has a particle size measured in an acetonitrile medium that is 0.60 μm or more and 1.0 μm or less in terms of volume-based median diameter and has a degree of swelling in water at pH 8 that is 25 or more and 40 or less.

2. The binder for non-aqueous electrolyte secondary battery electrodes according to claim 1,
wherein the crosslinked polymer or a salt thereof contains 60 mass % or more and 99.9 mass % or less of a first structural unit derived from an ethylenically unsaturated carboxylic acid monomer or a salt thereof and 0.1 mass % or more and 40 mass % or less of a second structural unit derived from a nitrogen-containing ethylenically unsaturated monomer.

3. The binder for non-aqueous electrolyte secondary battery electrodes according to claim 2,
wherein the second structural unit includes a structural unit derived from acryloylmorpholine.

4. The binder for non-aqueous electrolyte secondary battery electrodes according to claim 1,
wherein the crosslinked polymer or a salt thereof is a crosslinked polymer obtained by polymerizing a monomer composition containing a non-crosslinkable monomer and a crosslinkable monomer.

5. The binder for non-aqueous electrolyte secondary battery electrodes according to claim 4,
wherein the amount of the crosslinkable monomer used based on a total amount of the non-crosslinkable monomer is 0.1 mol % or more and 1.0 mol % or less.

6. The binder for non-aqueous electrolyte secondary battery electrodes according to claim 4,
wherein the crosslinkable monomer includes a crosslinkable monomer having two or more (meth)acryloyl groups and a hydroxyl group in one molecule.

7. The binder for non-aqueous electrolyte secondary battery electrodes according to claim 1,
wherein the crosslinked polymer or a salt thereof has a particle size of 0.75 μm or more and 0.95 μm or less and a degree of swelling in water of 27.9 or more and 36.8 or less, and is a lithium salt having a degree of neutralization of 80 mol % or more.

8. The binder for non-aqueous electrolyte secondary battery electrodes according to claim 1,
wherein the crosslinked polymer or a salt thereof contains a 70 mass % or more and 99 mass % or less of a first structural unit derived from an ethylenically unsaturated carboxylic acid monomer or a salt thereof and 1 mass % or more and 30 mass % or less of a second structural unit derived from a nitrogen-containing ethylenically unsaturated monomer, and
wherein the second structural unit includes a structural unit derived from acryloylmorpholine.

9. A non-aqueous electrolyte secondary battery, including a negative electrode containing the binder for non-aqueous electrolyte secondary battery electrodes according to claim 1, a positive electrode, and a non-aqueous electrolyte.
